(19) United States
(12) Patent Application Publication
(10) Pub. No.: US 2026/0065470 A1
(43) Pub. Date: Mar. 5, 2026

(54) ACCELERATED MRI IMAGE RECONSTRUCTION USING RECURRENT NEURAL NETWORK DESIGN

(71) Applicant: THE REGENTS OF THE UNIVERSITY OF CALIFORNIA, Oakland, CA (US)

(72) Inventors: Francisco Contijoch, San Diego, CA (US); Niraja Mahajan, La Jolla, CA (US); Ana Rodriguez Soto, La Jolla, CA (US); Nuri Chung, San Diego, CA (US)

(21) Appl. No.: 19/310,805

(22) Filed: Aug. 26, 2025

Related U.S. Application Data
(60) Provisional application No. 63/687,587, filed on Aug. 27, 2024.

(51) Int. Cl. G06T 7/00

(52) U.S. Cl. CPC G06T 7/0012; G06T 2207/10088; G06T 2207/20084

(57) ABSTRACT

Disclosed are systems and methods for accelerated reconstruction of dynamic, undersampled MRI data using a temporally-aware neural network system. An exemplary method includes receiving, for each of a plurality of time frames, undersampled k-space data; for one of the plurality of time frames, generating a reconstructed image by processing the undersampled k-space data for the time frame together with prior information derived from at least one previous time frame of the plurality of time frames, wherein the prior information comprises at least one of: (i) a k-space memory representing previously estimated or acquired k-space data, or (ii) an image-domain memory representing previously reconstructed images.

### CROSS-REFERENCE TO RELATED APPLICATIONS

This application claims priority to provisional application No. 63/687,587, titled “ACCELERATED IMAGE RECONSTRUCTION USING RECURRENT NEURAL NETWORK DESIGN,” filed on Aug. 27, 2024. The entire contents of the above noted provisional application are incorporated by reference as part of the disclosure of this document.

### STATEMENT REGARDING FEDERALLY SPONSORED RESEARCH OR DEVELOPMENT

This invention was made with government support under HL162671 awarded by the National Institutes of Health. The government has certain rights in the invention.

### TECHNICAL FIELD

The present technology relates to magnetic resonance imaging (MRI).

### BACKGROUND

MRI acquisition involves capturing detailed images of internal body structures using magnetic fields and radio waves. The process begins with a patient lying inside an MRI scanner, which generates a strong magnetic field to align the protons in the body. Radiofrequency pulses are then applied to disturb this alignment, and as the protons return to their original state, they emit signals. These signals are detected by receiver coils and transformed into images using Fourier transforms.

### SUMMARY

An aspect of the technology relates to a method for magnetic resonance imaging. The method includes: (a) receiving, for a time frame, a k-space data packet from a magnetic resonance imaging (MRI) system, the k-space data packet comprising an undersampled k-space sample for each of a plurality of coil channels; and (b) for each of the plurality of coil channels, (i) generating a filled k-space estimate by inputting an undersampled k-space sample acquired by the coil channel and a coil-specific k-space cell state from a previous time frame into a first machine learning model, wherein the coil-specific k-space cell state stores temporal information from prior k-space reconstructions for the coil channel; (ii) transforming the filled k-space estimate using an inverse Fourier transform to obtain a preliminary image; and (iii) producing an image by inputting the preliminary image and a coil-specific image-domain cell state from the previous time frame into a second machine-learning model, wherein the coil-specific image-domain cell state stores temporal information from prior image reconstructions; and (c) generating a combined image for the time frame by combining the images of the plurality of coil channels.

Another aspect of the technology relates to a method for training one or more machine learning models is provided. The method includes: obtaining training data comprising, for each of a plurality of time frames, a training data set comprising reference k-space data, a ground truth image, and undersampled k-space data for the time frame; iteratively performing, for each of the plurality of time frames: (i) training a first machine learning model to generate a filled k-space estimate by processing the undersampled k-space data and a coil-specific k-space cell state from a previous time frame, wherein: the first machine learning model comprises a forget gate and an input gate, the forget gate is configured to generate a mask for removing values from the coil-specific k-space cell state at k-space locations corresponding to a sampling pattern of the undersampled k-space data; and the input gate is configured to control integration of the undersampled k-space data with k-space values retained from the coil-specific k-space cell state at unsampled locations to contribute to generating the filled k-space estimate; and the training comprises optimizing at least one loss function including a k-space domain loss function determined based on the filled k-space estimate and the reference k-space data, a first image domain loss function configured to compare an inverse Fourier transform of the filled k-space estimate to the ground truth image, and a gate related loss function relating to performance of at least one of the forget gate or the input gate; and (ii) training a second machine learning model to generate an image by processing a preliminary image derived from the filled k-space estimate and a coil-specific image-domain cell state from the previous time frame, wherein the training comprises optimizing a second image domain loss function configured to compare the image to the ground truth image; and training the first and second machine learning models by accumulating gradients over at least a portion of the plurality of time frames and backpropagating the accumulated gradients to learn temporal relationships between consecutive time frames of the plurality of time frames. The method enables training of machine learning models configured to reconstruct high-quality MRI images from undersampled k-space data by integrating temporal memory mechanisms across several successive time frames through optimized gating functions and multi-domain loss functions that enforce data fidelity in both k-space and image domains. The method allows creations of deployable MRI reconstruction systems that provide real-time or near real-time imaging capabilities for clinical procedures and enable diagnostic imaging from undersampled acquisitions that reduce image acquisition times.

A further aspect of the technology relates to a method for magnetic resonance imaging. The method includes: receiving, for each of a plurality of time frames, undersampled k-space data; for one of the plurality of time frames, generating a reconstructed image by processing the undersampled k-space data for the time frame together with prior information derived from at least one previous time frame of the plurality of time frames, wherein the prior information comprises at least one of: (i) a k-space memory representing previously estimated or acquired k-space data, or (ii) an image-domain memory representing previously reconstructed images.

In a still further aspect of the technology, the above-described methods are embodied in the form of processor-executable code and stored in one or more non-transitory computer-readable storage media. The code included in the computer readable storage media when executed by one or more processors, causes the one or more processors to implement the methods described in this patent document.

In yet another aspect of the technology, a system is disclosed. The system includes: at least one processor; and memory with instructions stored thereon, wherein the instructions upon execution by the at least one processor, cause the at least one processor to performing the method of any one or more solutions disclosed herein.

The foregoing general description of the illustrative embodiments and the following detailed description thereof are merely example aspects of the teachings of this disclosure and are not restrictive.

### BRIEF DESCRIPTION OF THE DRAWINGS

Non-limiting and non-exhaustive examples are described with reference to the following figures.

FIG. 1 illustrates (a) exemplary MRI acquisition trajectories and (b) exemplary radial acquisition at golden angles.

FIG. 2 depicts an exemplary MD-CNN architecture.

FIG. 3 illustrates a sample image from the ACDC dataset.

FIG. 4 illustrates exemplary processing of the sample image in FIG. 3 to simulate k-space and image data from an MRI scanner.

FIG. 5 illustrates exemplary receiver coil simulation by multiplying the ACDC image in FIG. 3 with Gaussian masks.

FIG. 6 illustrates simulated undersampled data from 8 receiver coils.

FIG. 7 shows an example architecture of a FOURIER-Net pipeline.

FIG. 8 illustrates an exemplary k-space RNN cell.

FIG. 9 illustrates an exemplary image space RNN cell.

FIG. 10 illustrates a process for coil-wise prediction from an undersampled coil-wise k-space data to a coil-wise image, in combination with k-space cells state and image space cell state, using the RNN module as illustrated in FIG. 7.

FIG. 11 are exemplary coil-wise images generated by and output from the RNN module as illustrated in FIG. 7.

FIG. 12 shows an exemplary UNet configured to perform coil combination.

FIG. 13 shows exemplary results obtained by coil combination.

FIG. 14 shows comparison between an image obtained by FOURIER-Net reconstruction and an image obtained by MD-CNN reconstruction.

FIG. 15 shows intermediate predictions of an exemplary recurrent module.

FIG. 16 shows a lag in an exemplary FOURIER-Net prediction.

FIG. 17 illustrates a process for reconstructing dynamic magnetic resonance images from undersampled multi-coil k-space data, in accordance with embodiments of the present technology.

FIG. 18 illustrates a process for model training, in accordance with embodiments of the present technology.

FIG. 19 illustrates a process for reconstructing dynamic magnetic resonance images from undersampled multi-coil k-space data, in accordance with embodiments of the present technology.

FIG. 20 illustrates a block diagram of a computer system for image processing, in accordance with embodiment of the present technology.

### DETAILED DESCRIPTION

### 1. Introduction

The present patent document relates to systems, devices, and methods for accelerated reconstruction of images based on dynamic, undersampled magnetic resonance imaging (MRI) data.

MRIs are acquired in the frequency domain known as k-space, which brings the challenge of working with high-magnitude complex data. MRI acquisition involves capturing detailed images of internal body structures using magnetic fields and radio waves. The process begins with a patient lying inside an MRI scanner, which generates a strong magnetic field to align the protons in the body. Radiofrequency pulses are then applied to disturb this alignment, and as the protons return to their original state, they emit signals. These signals are detected by receiver coils and transformed into images using Fourier transforms.

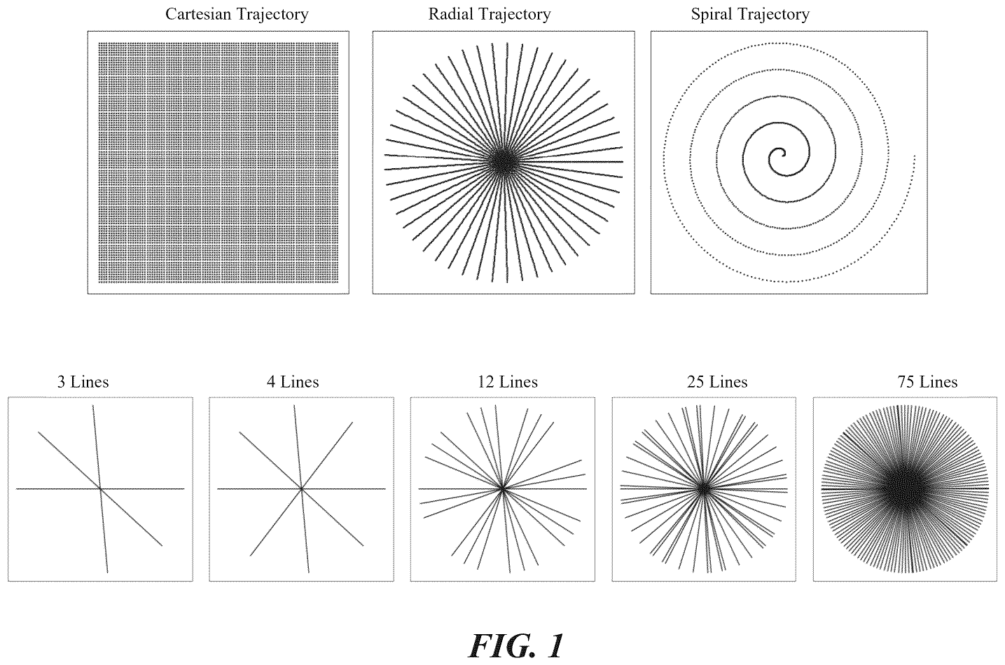

MRI acquisition can be done following various trajectories, such as Cartesian, radial, and spiral, as shown in (a) of FIG. 1. The acquisition is typically performed line by line in the k-space. In Cartesian sampling, lines are acquired sequentially in a grid pattern, while spiral sampling involves collecting data along a continuous spiral path. Radial sampling involves collecting data along spokes radiating from the centre of the k-space. Golden angle patterns are often used for radial sampling because they ensure that data is uniformly distributed across k-space, providing consistent coverage. In golden-angle radial acquisition, each spoke is approximately 111.25 degrees from the previous one. The main advantage of using golden angles is the flexibility it offers. Since the sampling is uniform at any point, the acquisition can be stopped at any time, and the collected data may still be evenly distributed, as demonstrated in (b) of FIG. 1. This results in better motion robustness and allows for real-time imaging applications, as the uniformity in k-space ensures high-quality image reconstruction even with fewer samples, which has been demonstrated for several medical applications like real-time imaging of, for example, cardiac function, fetal heart, or knee movement, among others.

The Non-Uniform Fast Fourier Transform (NUFFT) may be used to grid the k-space data from non-Cartesian trajectories like radial and spiral. Unlike the standard Fast Fourier Transform (FFT), which requires data points on a regular grid, NUFFT can handle the irregularly spaced data from these trajectories. It interpolates the non-uniform k-space data onto a Cartesian grid before applying the FFT, ensuring accurate image reconstruction.

MRI is used to guide a number of medical interventions today, if the image reconstruction time was increased to reduce latency, potentially more procedures could be performed with MRI guidance. In contrast to X-ray, the patient undergoing an MRI scan is not exposed to ionizing radiation, so there are no concerns with repeated exposure or health risks for vulnerable patients such as children or people undergoing radiation-based chemotherapy.

Cine MRI is a pulse sequence used to capture moving images, e.g., of the heart. It allows the visualization of cardiac motion and function and is commonly used in cardiology to assess heart structures and blood flow.

Cine MRIs need a high temporal resolution to capture rapid heart movements, but this comes at the cost of spatial resolution. Another problem is the respiratory motion, which can cause blurring. Hence, the patient often holds their breath during the scan to minimize or reduce motion artefacts caused by respiration. These breath-holds usually last about 10-20 seconds and are repeated several times throughout the procedure. Breath-holding is crucial as it stabilizes the chest and diaphragm, reducing blurring and ensuring clearer heart images.

During breath-holding, the acquired images are grouped into bins based on the cardiac cycle phase. Each bin corresponds to a specific point in the heart's rhythm, allowing for the reconstruction of a continuous, clear video of the cardiac cycle from multiple breath-holds. Binning helps achieve high temporal resolution by ensuring that images from similar phases of the cardiac cycle are combined.

For pediatric patients or patients with arrhythmia, cine MRI presents additional challenges. Pediatric patients often have difficulty holding their breath, leading to increased motion artefacts. Patients with arrhythmias pose a challenge due to irregular heartbeats, making it difficult to synchronize image acquisition with the cardiac cycle. This can result in inconsistent binning of the images or the introduction of unwanted respiratory motion.

Interventional Cardiovascular Magnetic Resonance (iCMR) is when MRI is used to guide cardiac procedures like catheterizations. Unlike CT scans, MRI does not emit harmful ionizing radiation, which can be dangerous for pediatric patients or for patients undergoing repetitive interventions. iCMR requires real-time image acquisition and fast display to guide interventional procedures. The real-time aspect of image reconstruction is crucial for the precision and safety of these procedures, and hence, iCMR needs real-time image reconstruction and display. However, unlike diagnostic MRI, there is no time available for extensive post-processing since iCMR reconstruction needs a latency of less than 200 ms. As a result, techniques like compressed sensing and complex neural networks, while effective for high-quality imaging, take significant post-processing time and are unsuitable for real-time use in iCMR.

Accelerated reconstruction methods like compressed sensing can be applied to singleshot data to improve the temporal and spatial resolutions. Research has been done involving compressed sensing to improve the acceleration factor. While this works for singleshot imaging of patients with arrhythmias, it involves a time-consuming post-processing step, and the real-time requirement of iCMR demands faster post-processing. Parallel imaging methods like SENSE and GRAPPA allow fast acquisition and display but are susceptible to noise and artefacts.

Cine MRIs generate a time series with high temporal similarity between successive data acquisitions. Neural Networks can exploit this similarity to reconstruct images at a very high acceleration factor while maintaining a good reconstruction quality. Recently, a Multi-Domain Convolutional Neural Network (MD-CNN) was proposed that can reconstruct high-quality images from highly undersampled radial k-space data.

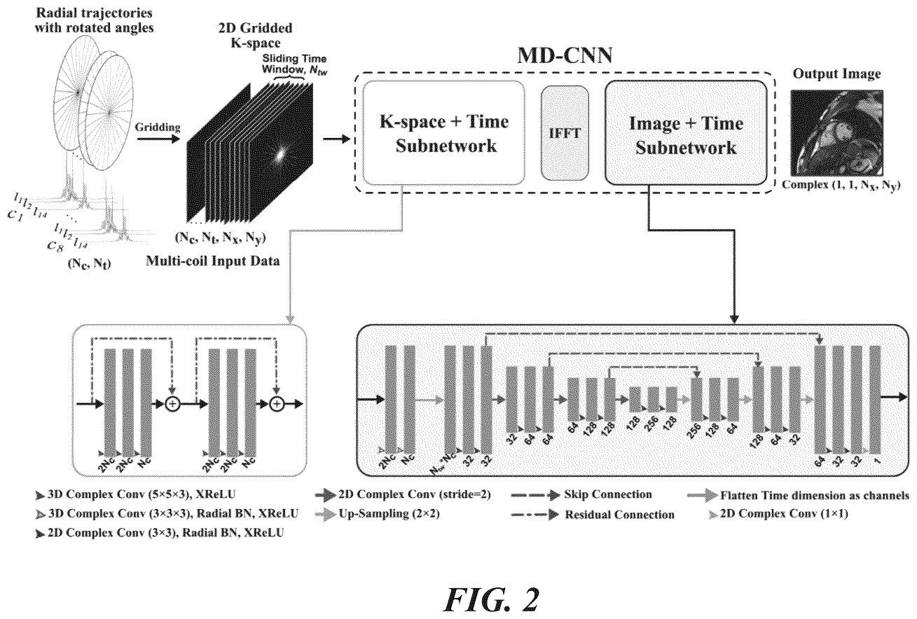

The architecture of the MD-CNN is shown in FIG. 2. They perform a 3D convolution on a sliding window of undersampled k-space frames to predict the fully sampled frame at the centre of the sliding window. The input to the MD-CNN is a 4D tensor of dimensions Nc×Nw×Nx×Ny. Here, Nc is the number of coils, Nw is the sliding-window size, and Nx×Ny is the image resolution.

The MD-CNN has two convolutional subnetworks: a k-space+time subnetwork and an image+time subnetwork. The k-space+time subnetwork has two complex 3D-convolutional blocks with residual connections. Each block has three 3D complex convolutional layers with an XReLU activation. The k-space+time subnetwork subnetwork operates on undersampled gridded k-space data. The k-space produced by this subnetwork is transformed to the image domain using an IFFT operation. In the image+time subnetwork, the temporal structure and information are first exploited by two 3D complex convolutional layers. The result is flattened to 2D feature maps, which are processed by a 2D UNet to produce a coil-combined prediction.

While the MD-CNN approach has several advantages, it has limitations when being applied to the iCMR setting. As the sliding window shifts across the time series, every frame is involved in multiple forward passes due to the overlap of the window, which adds to the reconstruction time. This also makes the window size a rigid hyperparameter, while it is desirable to increase and decrease the window sizes based on certain cardiac phases such as systoles or diastoles.

Recurrent Neural Networks (RNNs) may be better for inferences based on time series, as they are designed to model temporal patterns. However, they can be more difficult to train. RNNs have a very common issue of vanishing gradients, which may be solved by Long Short-Term Memory (LSTM). LSTM networks are better for inferences based on time-series as they intrinsically exploit temporal information and have a special memory unit that remembers long-term patterns and simultaneously forgets unimportant information. However, they can be more difficult to train. While LSTMs were initially proposed for ID time series, there has been significant work done on convolutional-LSTMs (convLSTMs), which are suitable for videos (time series of 2D frames). However, these architectures are designed for image-domain inputs. MRIs are acquired in the frequency domain known as k-space, which brings the challenge of working with high-magnitude complex data.

To address these and other technical challenges, the present disclosure describes a technology including a temporally-aware neural network system for accelerated (e.g., substantially real-time) reconstruction of dynamic, undersampled MRI data. The technology includes software that can generate images at a high frame rate, enabling (substantially) real-time display for surgical intervention without any processing delay that would cause lag. Example applications of the disclosed embodiments include surgery or other medical interventions that use MRI to guide the procedure (e.g., neurosurgery, prostate biopsy, breast biopsy, heart surgery, etc.). The disclosed embodiments, among other features and benefits, offer an approach to rapid, high-quality MRI reconstruction, addressing the need for real-time processing in applications including, e.g., Interventional Cardiovascular Magnetic Resonance (iCMR).

The disclosed embodiments provide a neural network (NN)-based approach to construct high quality MRI images without significant time costs. MRI guidance of an interventional procedure needs fast image reconstruction. As described in this patent document, the disclosed NN-based approach exploits the similarities between consecutive frames to improve intraoperative MRI (iMRI) image reconstruction. In some example implementations, the disclosed techniques can achieve a multi-fold speed-up in the iMRI reconstruction process without significant loss in image quality, thereby improving image reconstruction speed and/or quality. The disclosed embodiments relate to a FOURIER-Net (FOUrier Recurrent ImagE Reconstruction Network), which is a specialized neural network based on a convolutional Long Short-Term Memory (convLSTM), designed to work with undersampled k-space data. The disclosed embodiments leverage a k-space RNN and a convLSTM combined with a UNet for coil combination and denoising. Results to be described herein demonstrate that FOURIER-Net significantly accelerates reconstruction speed while maintaining high-quality output, offering a practical solution for real-time iCMR. FOURIER-Net offers fast reconstruction speed and substantial reduction in computational complexity and inference time, which makes FOURIER-Net suitable for clinical applications where speed is critical. Furthermore, intermediate supervision incorporated into the FOURIER-Net model enhances explainability, ensuring each component performs targeted optimizations. The effectiveness of FOURIER-Net in reconstructing undersampled k-space data for iCMR, considering the MD-CNN as a benchmark, are discussed in the description that follows along with accuracy and speed evaluations of the FOURIER-Net compared to the MD-CNN.

### 2. Exemplary Dataset Simulation

Merely for illustration purposes and not intended to be limiting, the Automated Cardiac Diagnosis Challenge (ACDC) dataset may be used for developing various models described herein. Other databases or sources may be used. The ACDC dataset contains Cine MR images acquired in breath-hold for N (150) patients at multiple slices (Ln slices for the nth patient). There was constant cardiac motion while acquiring cine images, and hence, the k-space data from a complete cardiac cycle is divided into

$${N}_{f}^{l , n}$$

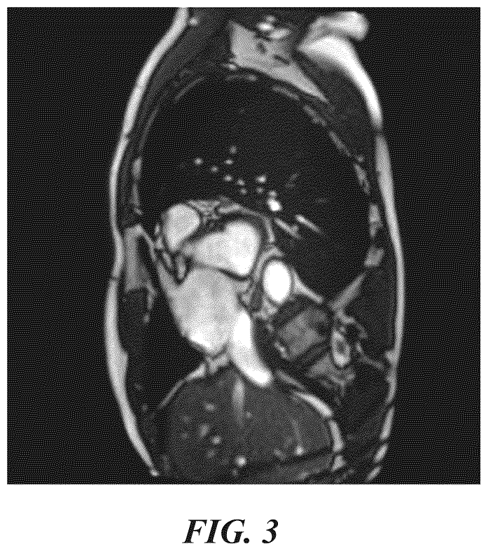

bins, where l and n are the corresponding slice and patient indices. This binning is done (approximately 30 histogram bins or frames) to reduce the blurring from the cardiac motion. The k-space data is acquired over multiple cardiac cycles, with patients holding their breath to minimize or reduce respiratory motion, and is aggregated in the respective bins to meet the Nyquist criteria for fully sampled k-space. The frames from the ACDC dataset may be looped to simulate data from multiple heartbeats. A complete cardiac cycle from the ACDC dataset x is given by y^{l,n} where l and n are the slice and patient indices. For simplicity, the (n,l) notations are dropped from all further equations. Each cardiac cycle may contain T (T^{n,l}) frames or bins, represented by y^{l}, t∈T. One such bin (or frame) is shown in FIG. 3. This ACDC dataset was used for simulated radial imaging, with 120 patients for training and 30 for testing.

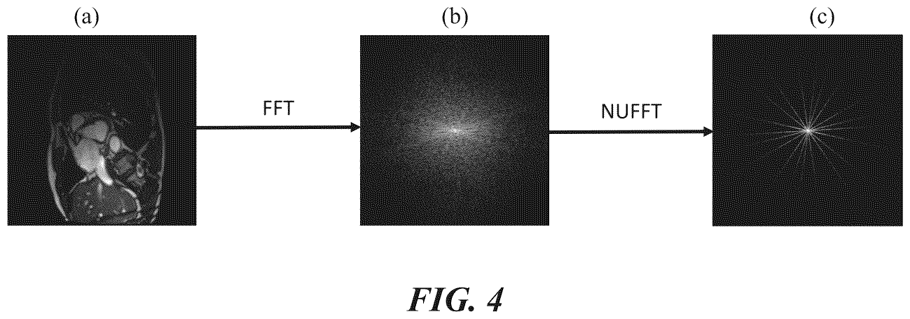

FIG. 4 illustrates exemplary processing of the sample image in FIG. 3 to simulate k-space and image data from an MRI scanner. Panel (a) of FIG. 4 shows the ground truth cine MRI frame from the ACDC dataset, also illustrated in FIG. 3. Panel (b) of FIG. 4 shows the corresponding k-space data. Panel (c) shows undersampled Fourier transform computed using NUFFT. The spokes were chosen at Golden Angle intervals.

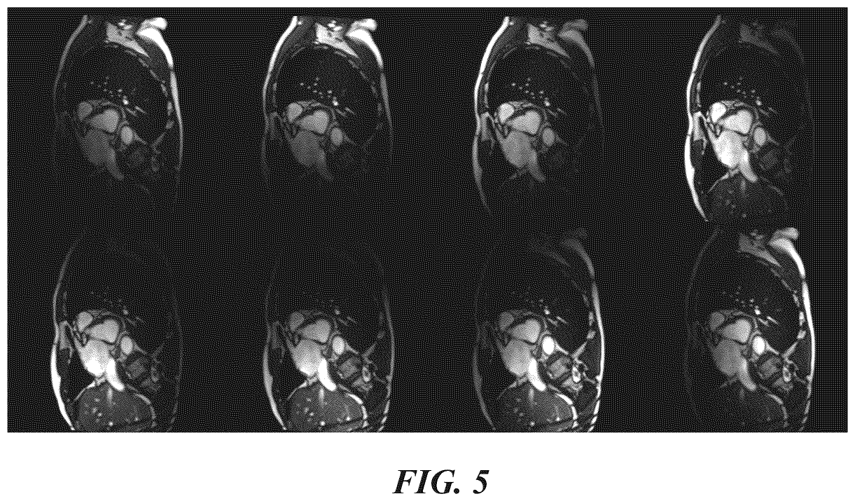

Receiver coils are the sensors physically present in the MRI machine that are responsible for detecting the MR signal. The signal recorded by each coil decays with the distance from the sensor. These receiver coils may be simulated by multiplying the ACDC images with C Gaussian masks [symbol] ^{C}, as shown in FIG. 5. For experiments described herein, 8 coils were simulated. These Gaussian masks can be randomly rotated for every slice-patient pair to ensure that the neural network does not overfit to a particular coil orientation.

$${y}^{t , c} = {c}^{} * {y}^{t} {∀}_{C} ∈ C , t \vert {N}_{f}^{l , n} \qquad ( Equation l )$$

Here, y^{t,c} is the simulated coil-wise ground truth of the ACDC images y^{t}.

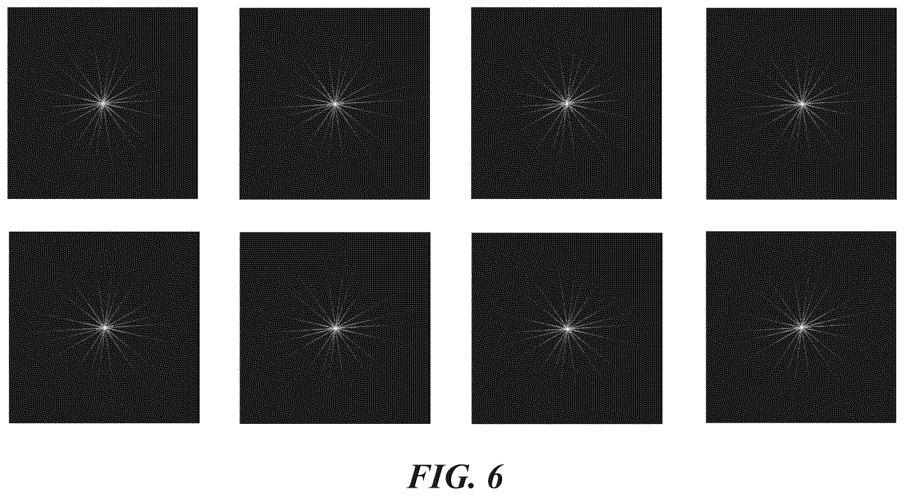

The images from the ACDC dataset are fully sampled (fully acquired k-space) images, which may serve as the ground truth for the neural network training. The Neural Network may be trained with undersampled k-space data as input. So, for illustration purposes and not intended to be limiting, 10 spokes of k-space data (radial acquisition) from each frame of the cardiac cycle are undersampled. These spokes are selected at golden angles to ensure uniformity. In radial sampling, k-space data are acquired along a radial spoke, which may have non-cartesian coordinates, whereas the ACDC images have data on a grid with integer coordinates. So, conventional fast-Fourier transforms are not used while undersampling. Instead, the Non-Uniform Fast Fourier Transform (NUFFT) operation is used to get the k-space data on non-cartesian coordinates and then grid it again to get radial spokes as shown in panel (c) of FIG. 4. FIG. 6 illustrates simulated undersampled k-space data from 8 receiver coils.

Thus, an undersampled multi-coil k-space time series is simulated and used as input for the neural networks.

$${X}^{t , c} = ( {y}^{tc} ) \qquad ( Equation 2 )$$

Here, [symbol] is the NUFFT operator, which produces an undersampled k-space X^{t,c} from the coil-wise data generated using Equation 1. This undersampled k-space is a complex number; it is represented using a bold font.

### 3. Exemplary FOURIER-Net

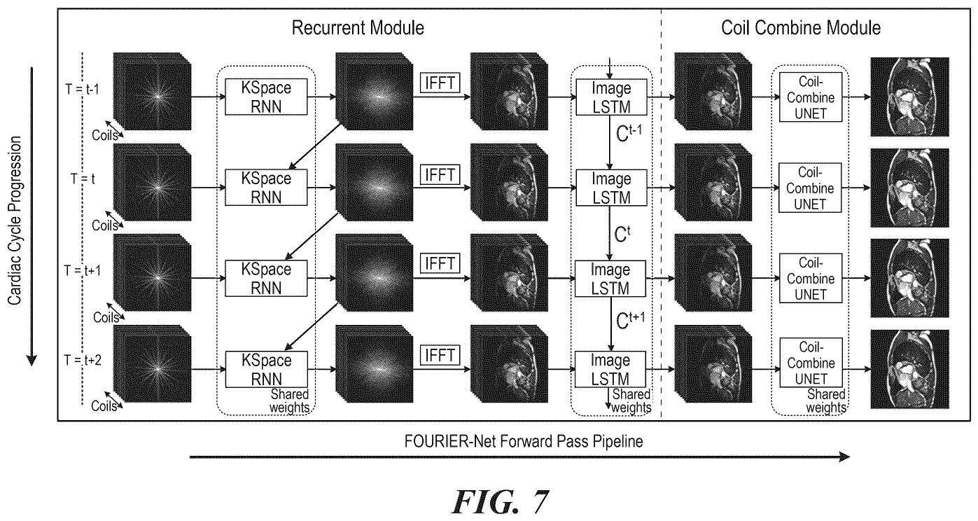

In some embodiments, the FOURIER-Net pipeline includes two components-a recurrent module and a coil-combine module, as shown in FIG. 7. The recurrent module has a k-space subnetwork and an image space subnetwork. In exemplary implementations, the k-space subnetwork is converted into a 2D convLSTM that interpolates missing k-space data in a coil-wise fashion. This reduced the FLoating-point OPerations (FLOPs) of the k-space subnetwork 38× from 140.9B (billion) to 3.7B; the image space subnetwork is streamlined to only include a UNet (and remove two 3D convolutional layers), which reduced FLOPS from 12.4B to 8.5B.

The convLSTM may be trained with intermediate supervision on the individual components. In addition to the final target image loss, intermediate supervisions may be performed using a k-space loss and an image loss immediately after the IFFT (before the image space UNet). In exemplary implewmentations, the model was trained for 1000 epochs using an Adam optimiser and a Cyclic LR Scheduler with limits (1e-4,8e-5).

FIG. 7 shows an example architecture of a FOURIER-Net pipeline. As shown in FIG. 7, the FOURIER-Net pipeline includes a recurrent module and a coil-combine module. The recurrent module comprises a k-space RNN and a convLSTM in the image space. Each coil can be sent independently to the recurrent module. The FOURIER-Net pipeline also includes an Nc (number of coils) time series, each with a single channel. The k-space RNN fills in the missing k-space in an undersampled input, though it may introduce artefacts and noise in the corresponding image-space prediction (after an Inverse Fast Fourier Transform). These artefacts and noise can be cleaned by a convLSTM in the image domain. The coil-combine module includes a UNet that performs coil-combination on the convLSTM prediction to reconstruct a denoised and artefact-free image.

The FOURIER-Net pipeline of FIG. 7 works with a time series of undersampled k-space frames. Each of these undersampled k-space frames has a number of spokes (N) acquired at golden angles. Each row of FIG. 7 indicates an independent forward pass for each undersampled frame, and the neural networks shown in FIG. 7 have shared weights across a column.

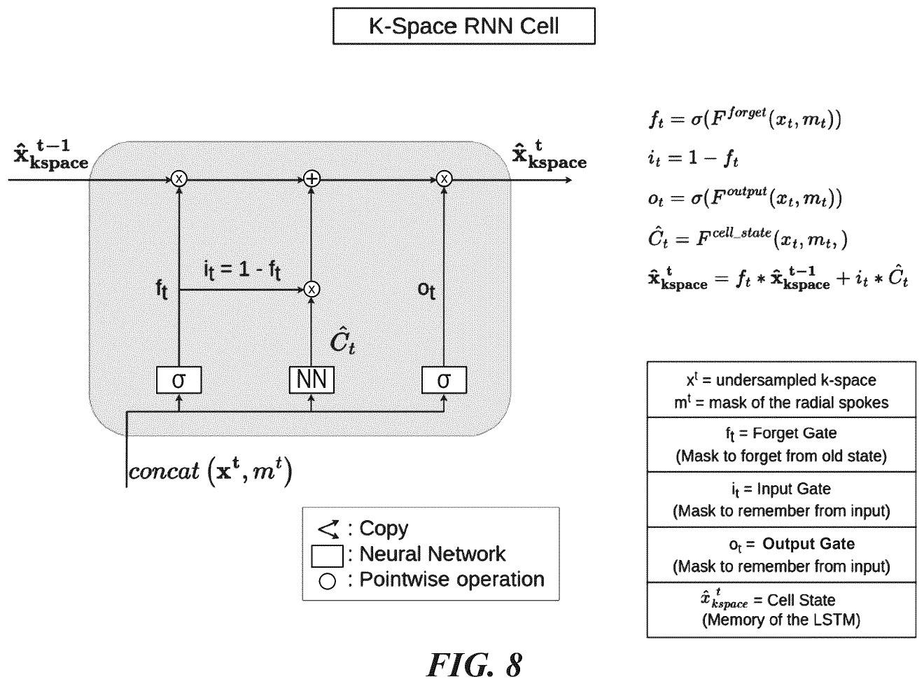

As shown in FIG. 7, the FOURIER-Net pipeline includes a k-space RNN. The k-space RNN network includes a memory unit, as shown in FIG. 8, which stores the latest k-space frame predicted by the network. For every new frame, the k-space RNN detects the angles at which the new data is acquired and updates this data into the memory to produce a new output.

Another way to look at the k-space RNN is a modified convLSTM. As shown in FIG. 8, the k-space RNN architecture as illustrated in FIG. 7 may be obtained by deleting the input gate, the output gate, and the tanh activation function from the standard convLSTM.

The k-space RNN is configured to train on and predict k-space data. Neural networks are usually designed for image-domain data, which typically have a small range of values (usually between 0 and 1). This makes them easier to train compared to k-space data, where the magnitude of values can be extremely high. In some implementations, the complex k-space data is split as magnitude and theta (obtained from the phase) and two copies of the k-space RNN weights are created to run independently on the magnitude and theta. In some implementations, the theta values are angles between (0, 2π), and the magnitudes, especially for the low-frequency values, are extremely large numbers. Hence, a log of the magnitudes is taken according to Equation 3 in order to bring them to a favourable range.

$${\hat{x}}_{kspace}^{t , c} = {F}_{k} ( {x}^{t , c} , {\hat{x}}_{kspace}^{t - 1 , c} , {m}^{t - 1} ) \qquad ( Equation 3 )$$

Here, Fₖ is the k-space RNN forward call.

$${\hat{x}}_{kspace}^{t , c}$$

is the RNN prediction for the r^{th} frame of the c^{th} coil. It is also the cell state for the forward pass of the next frame. m^{t} is the binary mask containing the locations of the newly acquired data. This may have N radial spokes.

As shown in FIG. 8, the input undersampled frame x^{t} and the previously predicted fully-populated frame

$${X}_{kspace}^{t - 1}$$

is concatenated and sent to a forget gate to produce a mask f^{t}. This mask is the result of a sigmoid function and has values between (0,1). This is multiplied to the cell state (the previously predicted frame) to forget redundant information. It also forces the cell state to forget information at locations where new data is acquired. The same concatenated data is processed by a neural network to produce Ĉ^{t}. A complementary mask is obtained from the forget gate mask called the input gate mask. This is multiplied to Ĉ^{t} and added to the updated cell state. This process recurrently continues for all frames in the example cardiac cycle of FIG. 7. The k-space RNN cell produces a fully populated frame

$${x}_{kspace}^{t}$$

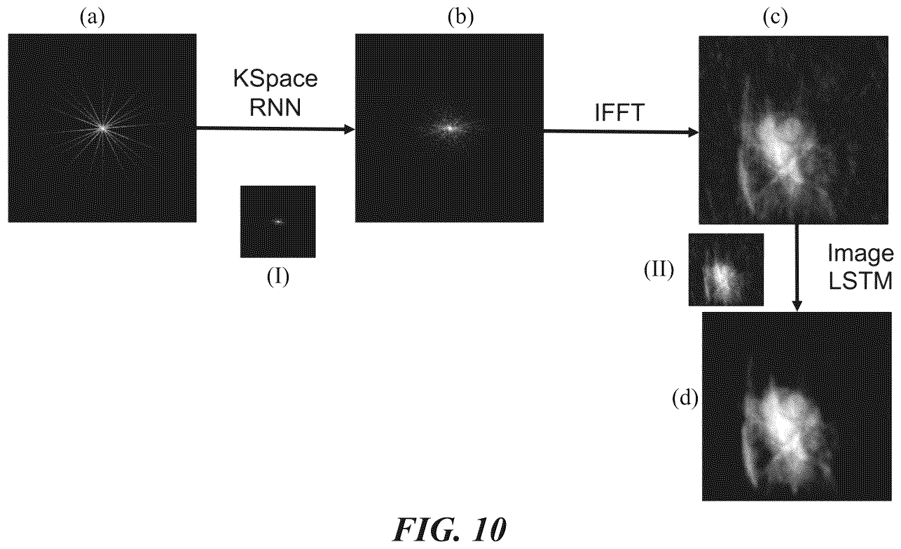

using an undersampled frame x^{t} and the corresponding mask containing the locations of the newly sampled data. In some implementations, the forget gate mask f^{t} is used to delete information from the cell state, while a complementary input gate is used to integrate new information in the cell state. In some implementations, the output gate scales and further masks the k-space data, which is returned as the prediction. See panels (a), (i), and (b) of FIG. 10. The k-space RNN processes the undersampled coil-wise k-space data as illustrated in panel (a) and the k-space cell state from a previous time frame as illustrate in panel (I) to generate the filled coil-wise k-space data as illustrated in panel (b) of FIG. 10.

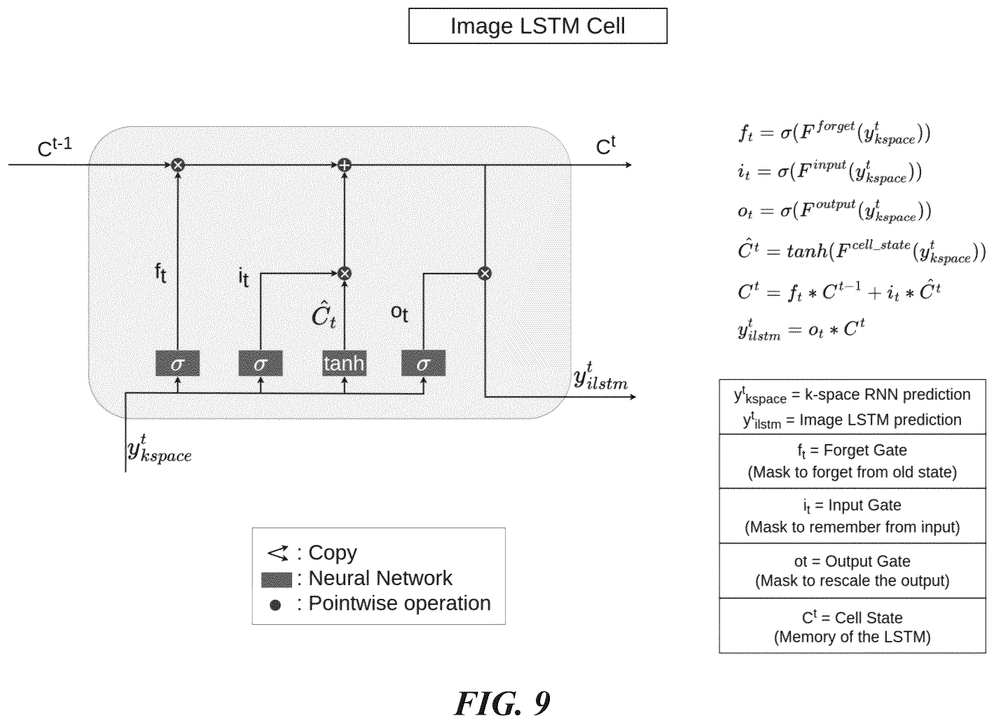

The FOURIER-Net pipeline of FIG. 7 includes a convLSTM, in the image domain, configured to remove artefacts and noise from the predicted image. An example network architecture for the image LSTM is shown in FIG. 9. In some implementations, each gate in the convLSTM is a 4-layer convolutional neural network. In some implementations, the convLSTM does not concatenate the previously predicted frame

$${y}_{iltsm}^{t - 1}$$

as input. Ims LSTM cleans up the k-space RNN output in the image domain and ensures smooth transitions between frames.

The forward pass for the convLSTM is shown in Equation 5. The inverse Fourier transform of the k-space RNN output from Equation 3 is taken to obtain

$${\hat{y}}_{kspace}^{t} .$$

Fⁱ is the image LSTM forward pass function.

$${\hat{y}}_{ilstm}^{t , c}$$

is the lstm prediction for the t^{th} frame of the c^{th} coil. C^{t} is the cell state, which is the memory unit of the architecture.

$${\hat{y}}_{kspace}^{t , c} = {ℱ}^{- 1} ( {\hat{x}}_{kspace}^{t , c} ) \qquad ( Equation 4 )$$

$$( {\hat{y}}_{ilstm}^{t , c} , {C}^{t} ) = {F}^{i} ( {\hat{y}}_{kspace}^{t , c} , {\hat{y}}_{ilstm}^{t - 1 , c} , {C}^{t - 1} ) \qquad ( Equation 5 )$$

Here [symbol] ⁻¹ is the inverse Fourier transform operator.

As illustrated in FIG. 10, the filled coil-wise k-space data as illustrated in panel (b) is converted to a coil-wise image as illustrated in panel (c) of FIG. 10. Then the coil-wise image in panel (c) and an image space cell state from a previous time frame as illustrated in panel (II) are input to the Image LSTM to generate a revised coil-wise image as illustrated in panel (d) of FIG. 10.

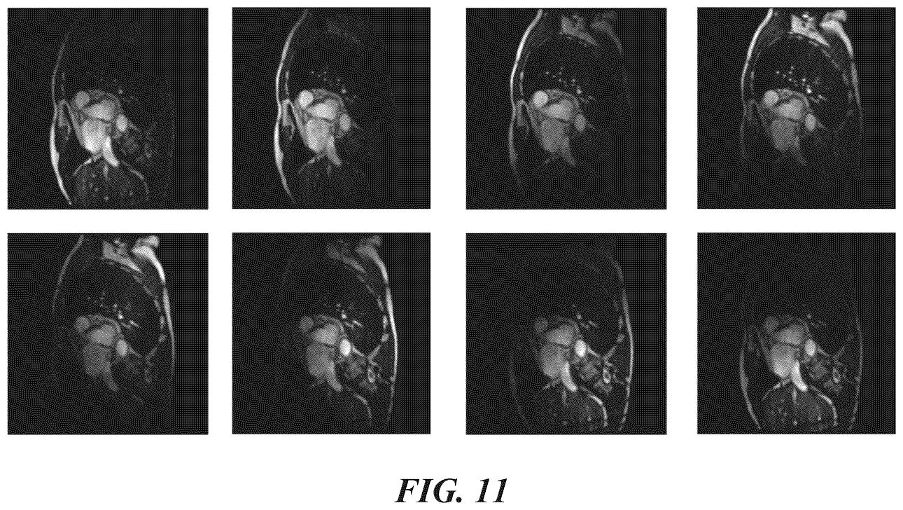

FIG. 11 are exemplary coil-wise images generated by and output from the RNN module as illustrated in FIG. 7.

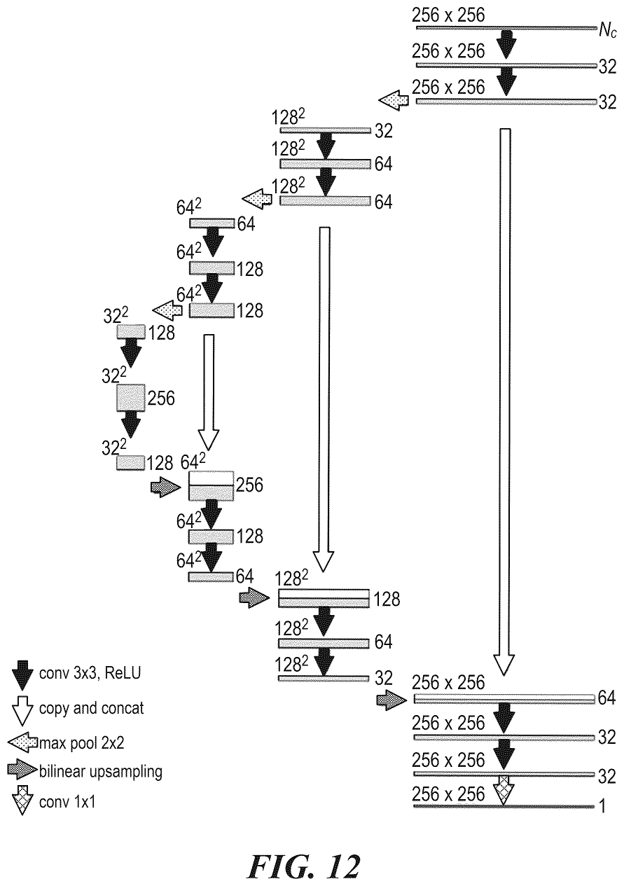

As shown in FIG. 7, the FOURIER-Net pipeline also includes a Coil-Combine UNet. In some implementations, the recurrent module populates data from every coil independently which can result in a deviation of the intensity values, making a few regions of the heart wall brighter than the ground truth. In this case, conventional coil-combination methods like the sum-of-squares give sub optimal results since the deviated pixels flare up in the squared sum. Instead, the FOURIER-Net pipeline utilizes a UNet as the last component in the pipeline that performs coil combination and image intensity correction. The UNet converts the Nc-channel (number of coils) input to a single-channel denoised prediction as shown in FIG. 12. In some implementations, there are skip connections across each depth of the UNet to ensure that the UNet retains fine-grain semantic information.

$${{\hat{y}}_{unet}^{t} = \{ {\hat{y}}_{ilstm}^{t , c} \} \vert}_{c ∈ C} \qquad ( Equation 6 )$$

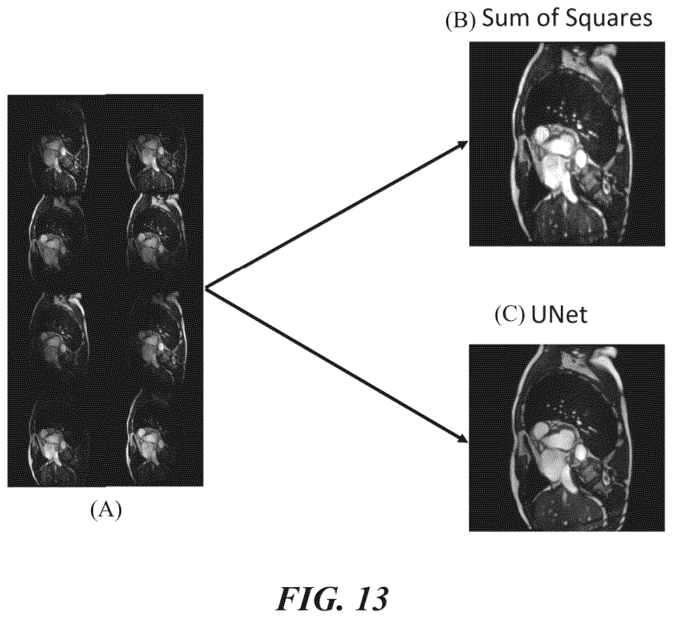

FIG. 13 shows results obtained by coil combination. Multiple coil-wise images corresponding to a same time frame in panel (A) of FIG. 13 (the same as or similar to those as shown in FIG. 11) are combined. Panel (B) shows a result image obtained by combining the coil-wise images by taking a sum of squares. Panel (C) shows a result image obtaining using a UNet that combines the coil-wise images while removing noise and artefacts from the image, giving a SSIM of 0.89, better than the SSIM of 0.76 for the result image shown in panel (B).

In some implementations, the recurrent module is trained by accumulating gradients over the entire time series and backpropagating together. To maximise or increase the time series length to ensure that the model learns temporal patterns, the recurrent module and the coil-combine UNet are trained independently to maximise or increase the GPU memory available for the recurrent module. The recurrent module is trained to match the simulated coil-wise ground truth obtained in Equation 1, while the UNet is trained to regenerate Automated Cardiac Diagnosis Challenge (ACDC) ground truth images.

The k-space RNN produces data in the Fourier space which is compared to the Fourier transform of the coil-wise ground truth y^{t,c} as exemplified in Equation 7. In some implementations, the IFFT of the k-space RNN prediction is compared with the coil-wise ground truth to determine a loss in the real domain as exemplified in Equation 8.

$${L}_{krnn}^{complex} = \frac{1}{{N}_{f} \cdot C} {\sum }_{c , t} \vert log ( {\hat{x}}_{kspace}^{t , c} ) - log ( ℱ ( {y}^{t , c} ) ) \vert \qquad ( Equation 7 )$$

$${L}_{krnn}^{real} = \frac{1}{{N}_{f} \cdot C} {\sum }_{c , t} {( {\hat{y}}_{kspace}^{t , c} - {y}^{t , c} )}^{2} \qquad ( Equation 8 )$$

Here [symbol] is the Fourier transform operator, and N_{f} and C are the total number of frames and the number of coils, respectively. A loss on the gates is shown in Equation 9. A loss is applied on the input gate mask and the intermediate cell state generated by the k-space RNN of FIG. 8 Here * is the Hadamard product operation. This loss adds a two-fold supervision on the RNN working. The first component ensures that the k-space data at the newly acquired locations is deleted from the cell state. The second and third component is a data fidelity term, which constrains the intermediate cell state to match the real k-space data from the scanner at the acquired locations.

$${L}_{krnn}^{gate} = \frac{1}{{N}_{f} \cdot C} {\sum }_{c , t} \{ \vert {i}_{t} * {m}^{t} - {m}^{t} \vert + \vert {\hat{x}}_{kspace}^{t ,} - {x}^{t} * {m}^{t} \vert \} \qquad ( Equation 9 )$$

The k-space RNN can be trained using one or more of these or other loss functions. For example, the k-space RNN can be trained using a weighted sum of these loss functions, as shown in Equation 10.

$${L}_{krnn} = {L}_{krnn}^{complex} + {λ}_{1} \cdot {L}_{krnn}^{real} + {λ}_{2} \cdot {L}_{krnn}^{gate} \qquad ( Equation 10 )$$

Similar to the k-space RNN real loss, a Mean Squared Error (MSE) loss can be computed between the Image LSTM prediction from Equation 5 with the coil-wise ground truth y^{t,c}.

$${L}_{ilstm} = \frac{1}{{N}_{f} \cdot C} {\sum }_{c , t} {( {\hat{y}}_{ilstm}^{t , c} - {y}^{t , c} )}^{2} \qquad ( Equation 11 )$$

The UNet performs coil-combination and produces a single combined image

$${\hat{y}}_{unet}^{t}$$

for every frame in the example cardiac cycle of FIG. 7, as shown in Equation 6. In some implementations, the MSE loss of this prediction with the ground truth y^{t} from the ACDC dataset is minimized or reduced.

$${L}_{unet} = \frac{1}{{N}_{f} \cdot C} {\sum }_{t} {( {\hat{y}}_{unet}^{t} - {y}^{t} )}^{2} \qquad ( Equation 12 )$$

Since there exists intermediate supervision for all models, the gradient is not backpropagated in an end-to-end fashion. In some implementations, the gradients are detached from the computation tree before the predictions are sent to the UNet.

In some implementations, the FOURIER-Net pipeline architecture can be trained using a multi-GPU paradigm (e.g., on 2 NVIDIA RTX 3090 GPUs with 25 GB memory). In one example, a cyclic LR scheduler with an exponential decay mode using the PyTorch library is used to train the FOURIER-Net pipeline architecture. In this example, the recurrent module is first trained for 200 epochs and then the UNet is trained for 200 epochs-a total training of 400 epochs. A batch size of 1 is used, while maximising or increasing the length (40) of the input sequence. In the example, the gradient is accumulated over this sequence of 38 images and backpropagated together. The gradient for the first 8 images was not computed since the model needs a few frames to “ramp up”, that is, build up enough history in the cell state.

Performance metrics describing the effectiveness of an example FOURIER-Net in reconstructing undersampled k-space data for iCMR, considering the MD-CNN as a benchmark, are presently described. The speed of both the FOURIER-Net and MD-CNN using the time taken to produce a frame using an undersampled frame with 10 spokes was measured. The model complexity was also measured by comparing the Floating Point Operations (FLOPs) of both architectures. To evaluate the FOURIER-Net reconstruction quality, the SSIM, L1 loss and the RMSE was measured. Additionally, a qualitative analysis can be performed and the difference frames of the predictions from both methods with the ground truth can be visualized.

### 4. Exemplary Results

The quantitative performance of the FOURIER-Net was evaluated, with the MD-CNN as a benchmark. As shown in Table I, the FOURIER-Net has significantly less Floating Point Operations than the MD-CNN. These directly translate to the time for a forward pass on the GPU and frames per second (FPS). In this example, the FOURIER-Net takes just 7.81 ms per frame for a forward pass, while the MD-CNNs need around 58.45 ms.

TABLE I
Example reconstruction speed measured using time for reconstruction,
frames per second (FPS), and FLOPS (Floating Point Operations)

| | Time for Recon | | FLOPs |
|---|---|---|---|
| Method | (ms) | FPS | (in Billions) |
| MD-CNN | 58.45 | 17.11 | 13.7 |
| FOURIER-Net | 7.81 | 128.04 | 190.2 |

While the FOURIER-Net has a superior speed gain, it falls marginally short of the MD-CNN in the reconstruction SSIM score, as shown in Table II.

TABLE II
Reconstruction quality results of the FOURIER-Net
and MD-CNN measured by SSIM, L1 and RMSE scores

| Method | L1 score | RMSE score | SSIM |
|---|---|---|---|
| MD-CNN | 0.016 | 0.026 | 0.907 |
| FOURIER-Net | 0.018 | 0.034 | 0.888 |

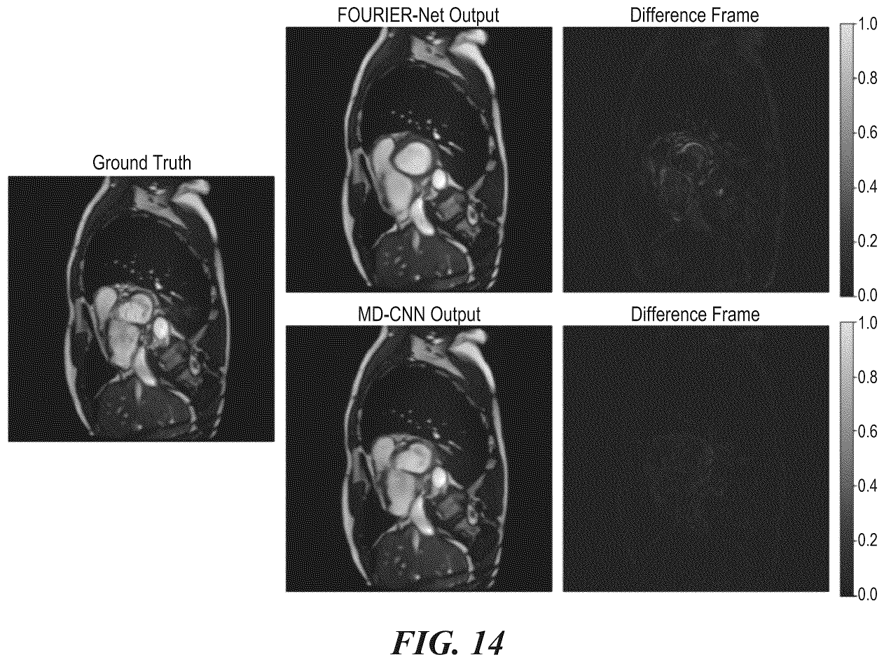

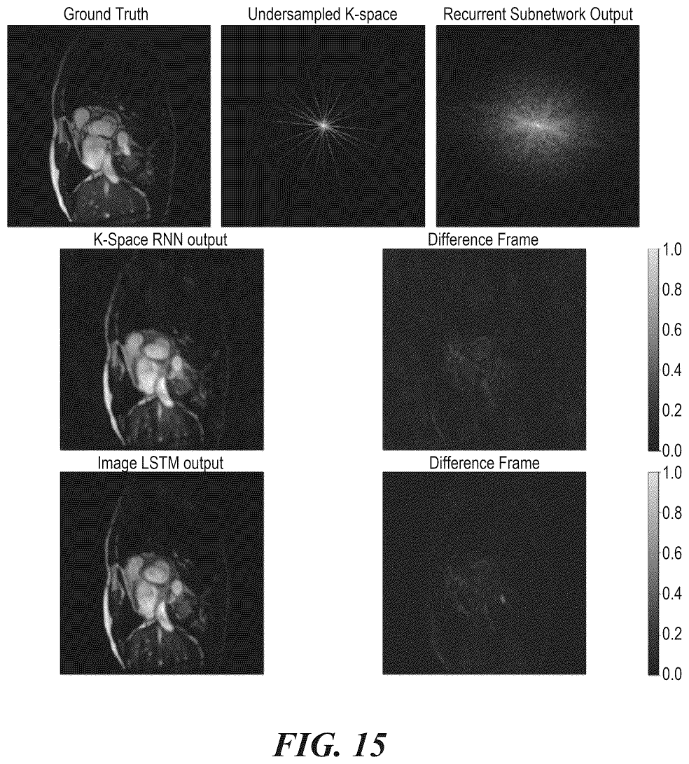

The qualitative performance of the FOURIER-Net was next evaluated. FOURIER-Net reconstructions were compared with the MD-CNN as shown in FIG. 14. The difference frames of the MD-CNN reconstruction are marginally better than the FOURIER-Net, which is also evident from the quantitative results. FIG. 15 shows example visualizations of the intermediate prediction of the recurrent module. The first row of FIG. 15 shows the coil-wise ground truth, undersampled input, and the model output. The second row of FIG. 15 highlights images produced by the k-space RNN, significantly improving the undersampled input. The third row of FIG. 15 shows denoised and artefact-free images from the image LSTM (i.e., convLSTM).

Example results from an ablation study of the FOURIER-Net are presently described. In the ablation study, components from the FOURIER-Net pipeline were systematically deleted and the architecture was retrained. The SSIM values were compared with the base architecture to show the impact of each component in Table II. Table II shows that deleting the k-space RNN results in the largest drop in the SSIM, which implies that most of the reconstruction happens in the k-space. If the UNet is replaced with a naive sum of squares, the SSIM drops to 0.76. The image LSTM is primarily responsible for denoising and artefact removal. SSIM is inherently robust to minor noise so the SSIM does not change much when the Image LSTM is deleted.

TABLE III
Example ablation study of the individual
components of FOURIER-Net

| Component Deleted | SSIM |
|---|---|
| No deletions | 0.888 |
| Image LSTM | 0.879 |
| UNet | 0.762 |
| K-space RNN and Image LSTM | 0.746 |
| Zero Filling (all neural networks deleted) | 0.273 |

The FOURIER-Net has much better explainability than the MD-CNN since every component of the FOURIER-Net performs a specific task rather than a black-box computation. Additionally, intermediate supervision is present for every component, making the neural network model extremely tractable. Furthermore, the recurrent module operation is independently performed for each coil, unlike the MD-CNNs that use an Nc-channel input and distribute all information into an extremely large latent space. By imposing such tractability, the reconstruction task is made easier for the FOURIER-Net, which also reduces the number of parameters used.

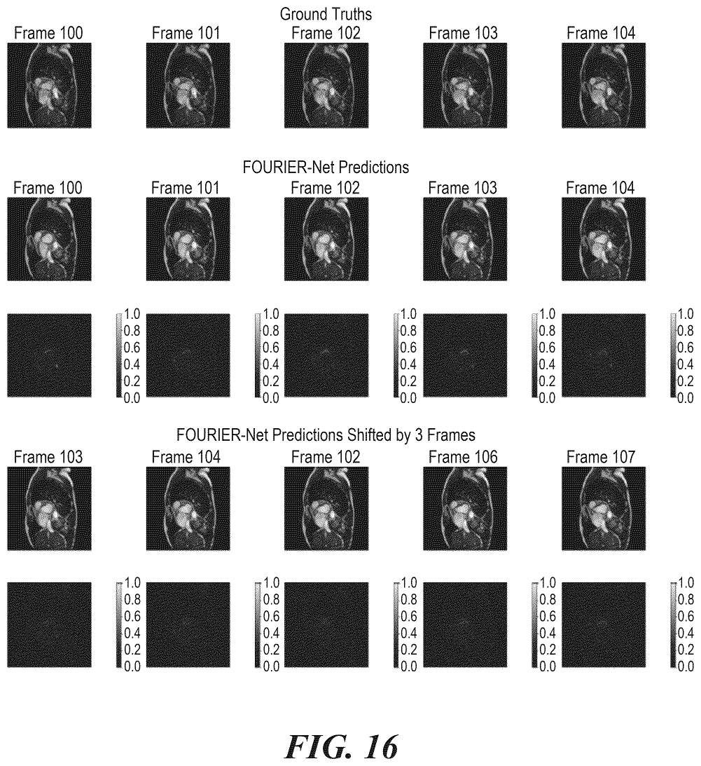

FIG. 16 shows an example of a lag correction which can be made to correct a lag in the FOURIER-Net prediction. Each frame in FIG. 16 is predicted with some lag; that is, at any time step, the FOURIER-Net prediction matches the ground truth that was a few frames prior. The FOURIER-Net prediction can be shifted by different amounts of lag and compared to the SSIM in Table IV.

TABLE IV
The SSIM can be computed by considering a varying
lag in the FOURIER-Net prediction. The SSIM value
peaks for a lag of 3 frames in this example.

| Lag Correction | SSIM |
|---|---|
| 0 | 0.888 |
| 1 | 0.892 |
| 2 | 0.894 |
| 3 | 0.896 |
| 4 | 0.895 |
| 5 | 0.893 |
| 6 | 0.891 |

In some implementations, lag is observed. The lag may be due to, for example, the FOURIER-Net does not delete many old k-space lines from memory, so the model responds a bit late to the newly added data. One example solution to fix this lag is to constrain the amount of data that is stored by the Neural Network by forcing the FOURIER-Net to forget the old data from the memory. In some implementations, a window size of a given number of frames, e.g., w frames, is maintained and after every forward pass, the model is forced to forget the data that was added w frames before.

The exemplary FOURIER-Net, a specialized neural network described herein is designed to reconstruct undersampled k-space data for Interventional Cardiovascular Magnetic Resonance (iCMR). The approach leverages a k-space RNN and a convLSTM combined with a UNet for coil combination and denoising. The results demonstrate that FOURIER-Net significantly accelerates reconstruction speed while maintaining high-quality output, offering a practical solution for real-time iCMR.

The performance of the FOURIER-Net was compared against the MD-CNN benchmark, highlighting the method's faster reconstruction speed. Despite the slight drop in SSIM, the substantial reduction in computational complexity and inference time makes FOURIER-Net suitable for clinical applications where speed is critical. Furthermore, the intermediate supervision incorporated into the model enhances explainability, ensuring each component performs targeted optimizations.

In some embodiments, a technique to fix a prediction lag is used, including retraining the network with the window-constrained forgetting. There is also scope for integrating adaptive methods like ARKS (Autonomous and closed-loop control system for Radial K-space Sampling) into the FOURIER-Net pipeline. Incorporating FOURIER-net into such adaptive methods' framework can not only improve image quality but also reduce image reconstruction time.

FOURIER-Net disclosed herein offers an approach to rapid, high-quality MRI reconstruction, addressing the critical need for real-time processing in iCMR.

### 4. Exemplary Processes of Model Application/Training and Computer Systems

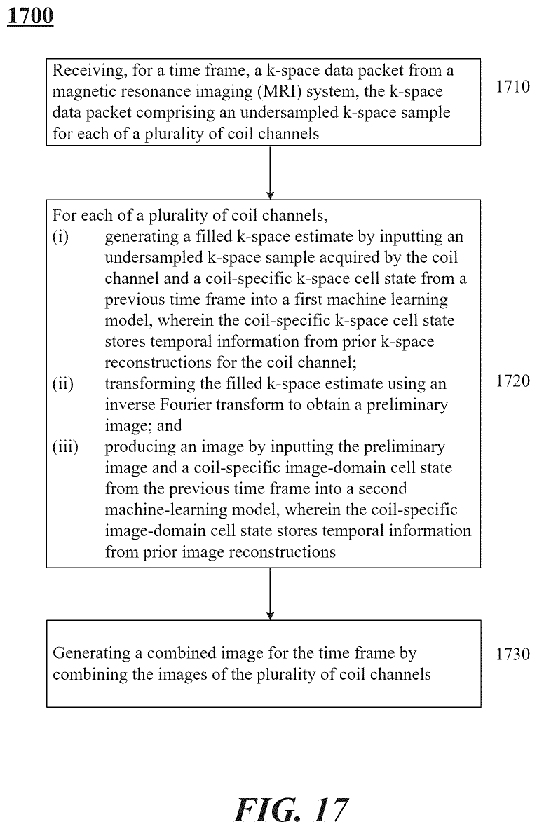

FIG. 17 illustrates a process 1700 for reconstructing dynamic magnetic resonance images from undersampled multi-coil k-space data, in accordance with embodiments of the present technology.

At 1710, the process 1700 includes receiving, for a time frame, a k-space data packet from a magnetic resonance imaging (MRI) system. The k-space data packet includes an undersampled k-space sample for each of a plurality of coil channels. The k-space data may include complex-valued frequency domain data. The data acquisition may be based on radial sampling patterns, such as golden-angle radial trajectories that provide uniform k-space coverage over time. This undersampled acquisition approach is advantageous for dynamic imaging applications requiring high temporal resolution, including real-time cardiac imaging during interventional procedures, pediatric imaging where breath-holding is difficult, fetal cardiac imaging, imaging of patients with arrhythmias or irregular heartbeats, abdominal imaging with respiratory motion, imaging of moving joints such as knee flexion studies, and gastrointestinal imaging where patient cooperation may be limited. The undersampled nature of the data enables faster acquisition times essential for capturing rapid physiological processes while maintaining spatial resolution, making the technology suitable for interventional cardiovascular magnetic resonance (iCMR) procedures that needs (substantially) real-time image guidance with latencies under 200 milliseconds. In some embodiments, the latency may be below 100 milliseconds, or below 50 milliseconds, or below 20 milliseconds, etc.

In some embodiments, the k-space data packet includes complex-valued data that is separated into magnitude and phase components for subsequent processing. In some embodiments, the k-space data packet is acquired using a golden-angle radial sampling pattern. In some embodiments, the k-space data packet includes non-Cartesian k-space samples. The samples may be mapped or resampled onto a Cartesian grid by performing a gridding operation prior to input into machine learning models. The gridding operation may be implemented using a non-uniform fast Fourier transform (NUFFT) technique. The resulting k-space samples may be provided as input for further processing according to the process 1700, without an additional Fourier transform operation.

At 1720, the process 1700 includes the operations performed for each of the plurality of coil channels, including three sub-operations. First, a filled k-space estimate is generated by inputting an undersampled k-space sample acquired by the coil channel and a coil-specific k-space cell state from a previous time frame into a first machine learning model. The coil-specific k-space cell state stores temporal information from prior k-space reconstructions for the specific coil channel.

In some embodiments, the first machine learning model includes a recurrent neural network architecture. In some embodiments, the first machine learning model includes a forget gate configured to generate a mask for removing values from the coil-specific k-space cell state at k-space sampled locations corresponding to newly acquired k-space samples for the coil channel, and an input gate configured to control integration of the newly acquired k-space samples with k-space values retained from the coil-specific k-space cell state at unsampled locations to contribute to generating the filled k-space estimate. The forget gate and the corresponding input gate may be complementary. For example, the sum of the forget gate and the corresponding input gate is 1. The forget gate and the input gate may also be referred to as the forget gate mask or the input gate mask.

In some embodiments, the process 1700 includes updating the coil-specific k-space cell state with the filled k-space estimate. The updated coil-specific k-space cell state is configured for use as a coil-specific k-space cell state from a previous time frame in generating a filled k-space estimate for a subsequent time frame for the coil channel.

Second, the filled k-space estimate is transformed using an inverse Fourier transform to obtain a preliminary image. Third, an image is produced by inputting the preliminary image and a coil-specific image-domain cell state from the previous time frame into a second machine learning model. The coil-specific image-domain cell state stores temporal information from prior image reconstructions. In some embodiments, the second machine learning model comprises a convolutional long short-term memory (convLSTM) architecture.

In some embodiments, the second machine learning model is trained to determine an updated coil-specific image-domain cell state that encodes a temporal relationship between the preliminary image and at least one previous time frame for the same coil channel, with the updated coil-specific image-domain cell state being configured for use as a coil-specific image-domain cell state from a previous time frame in reconstructing an image for a subsequent time frame for the same coil channel. In some embodiments, the second machine learning model includes a forget gate configured to generate a mask for selectively removing information from the coil-specific image-domain cell state based on the preliminary image, and an input gate configured to control integration of new information derived from the preliminary image with retained information from the coil-specific image-domain cell state to contribute to generating the image.

In some embodiments, only a portion of the prior temporal information is involved in the reconstruction process. For example, only k-space domain temporal information is used in the reconstruction process by employing the first machine learning model, or only image domain temporal information is used by employing the second machine learning model.

At 1730, the process 1700 includes generating a combined image for the time frame by combining the images from the plurality of coil channels determined at 1820. In some embodiments, combining the images comprises inputting the images into a third machine learning model that is trained to perform coil combination to generate the combined image. The third machine learning model may include a U-Net architecture or other neural network configured to learn optimal coil combination weights and perform intensity correction across the multiple coil channels. In some embodiments, the coil combination is performed using conventional non-machine learning methods, such as sum-of-squares combination where the magnitude images from each coil are squared, summed, and square-rooted to produce the final combined image, or sensitivity-weighted combination methods that use pre-computed coil sensitivity maps to optimally weight the contribution from each coil channel based on the spatial sensitivity profile of the respective receiver coils.

The process 1700 incorporates several additional features in various embodiments. Each coil channel of the plurality of coil channels operates independently with its own coil-specific k-space cell state and coil-specific image-domain cell state, such that temporal information for each coil channel is maintained separately without cross-coil information sharing. In some embodiments, the process 1800 includes compensating for temporal prediction lag by configuring the first machine learning model to limit retention of historical k-space data in the coil-specific k-space cell state to a predetermined number of prior time frames prior to the time frame, or by applying a temporal shift correction to align reconstructed images with their corresponding acquisition time frames. In some embodiments, the first machine learning model is configured such that the forget gate of the first machine learning model removes k-space data from the coil-specific k-space cell state that exceeds the predetermined number of prior time frames.

The process 1700 may include generating image sequences by repeating the operations for each of a plurality of time frames, with each combined image corresponding to undersampled k-space data acquired for the respective time frame, and generating an image sequence for the plurality of time frames based on a plurality of the combined images.

In some embodiments, the process 1700 is applied to reconstruct images of anatomical regions including the heart during cardiac catheterization procedures, lung imaging for respiratory motion assessment, abdominal organs such as the liver and kidneys during interventional procedures, pelvic organs for gynecological or urological interventions, fetal cardiac imaging where maternal breath-holding is not feasible, pediatric patients who have difficulty remaining still during scanning, gastrointestinal tract imaging for motility studies, or dynamic joint imaging such as knee movement during flexion-extension exercises.

In some embodiments, the process 1700 is configured for real-time or near-real-time reconstruction with a latency of less than 200 milliseconds per time frame, which is desirable for interventional cardiovascular magnetic resonance (iCMR) applications or other imaging guided surgeries or procedures where clinicians need immediate image feedback for procedural guidance. The reconstruction latency may be less than 150 milliseconds, 100 milliseconds, 80 milliseconds, 60 milliseconds, 50 milliseconds, 40 milliseconds, 30 milliseconds, 20 milliseconds, etc.

In some embodiments, the process 1700 includes evaluating quality of the generated image using quantitative metrics including at least one of structural similarity index (SSIM) for assessing perceptual image quality, L1 loss for measuring pixel-wise reconstruction accuracy, or root mean squared error (RMSE) for quantifying overall reconstruction fidelity compared to fully-sampled reference images. These metrics enable objective assessment of reconstruction performance across different anatomical regions and scanning conditions.

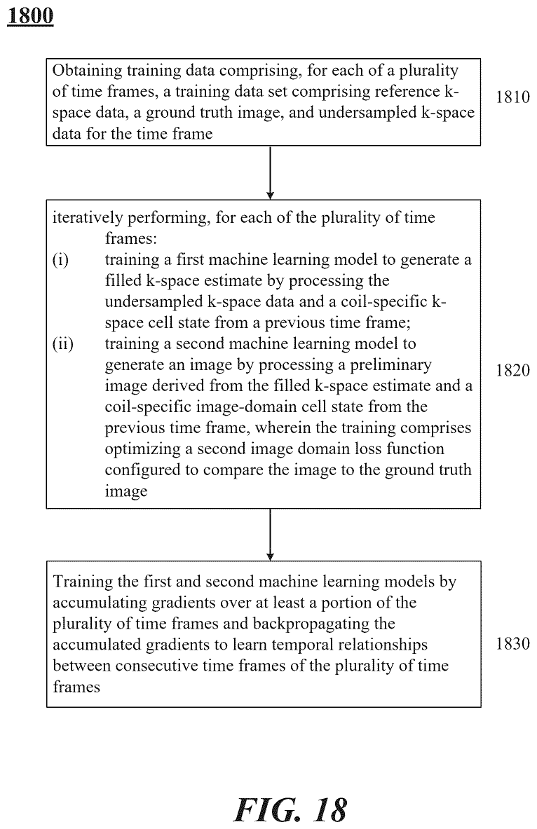

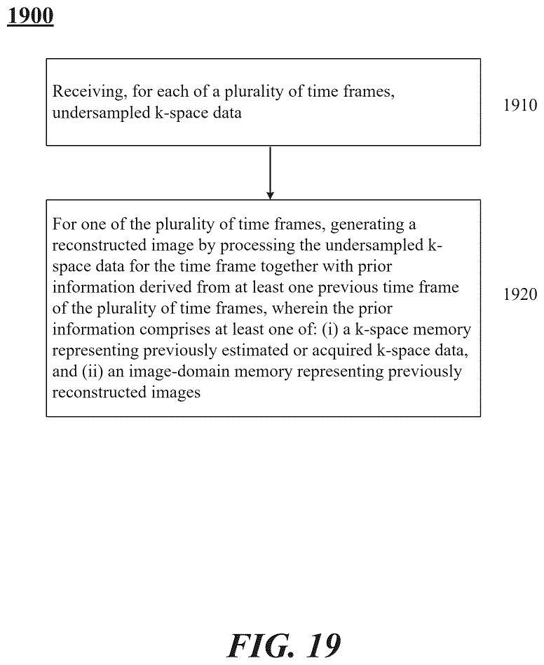

FIG. 18 illustrates a process 1800 for model training, in accordance with embodiments of the present technology. The machine learning models may be trained to be used in magnetic resonance image reconstruction from undersampled multi-coil k-space data including, e.g., processes 1700 and 1900 illustrated in FIGS. 17 and 19, respectively.

At 1810, the process 1800 includes obtaining training data. The training data may include, for each of a plurality of time frames, a training data set that includes reference k-space data, a ground truth image (or referred to as a reference image), and undersampled k-space data for the time frame. In some embodiments, the training data is obtained by determining reference k-space data by, e.g., performing a Fourier transform of a corresponding ground truth image of one of the plurality of time frames. Exemplary sources of the training data include publicly available cardiac MRI datasets such as the Automated Cardiac Diagnosis Challenge (ACDC) dataset containing fully-sampled cine MR images acquired during breath-holds from multiple patients, clinical cardiac imaging databases with retrospectively cardiac-gated acquisitions that provide complete cardiac cycle data, synthetic datasets generated by applying forward MRI physics models to anatomical phantoms or computational models, historical patient imaging data from clinical scanners that has been anonymized and processed to extract fully-sampled reference images, multi-institutional research collaborations that provide diverse cardiac imaging data across different scanner manufacturers and field strengths, pediatric cardiac imaging datasets that capture the unique challenges of imaging smaller hearts with faster heart rates, and fetal cardiac MRI datasets that demonstrate rapid physiological motion requiring high temporal resolution imaging approaches.

As an example, reference k-space data is obtained by performing Fourier transform on a ground truth image. As another example, a ground truth image is obtained by performing an inverse Fourier transform on reference k-space data. As a further example, the undersampled k-space data is determined by undersampling the reference k-space data using one or more of various sampling patterns to simulate the acquisition conditions that may be encountered during actual MRI scanning.

At 1820, the process 1800 includes performing an iterative training process for each of the plurality of time frames. The training process includes two main training operations. First, a first machine learning model is trained to generate a filled k-space estimate by processing the undersampled k-space data and a coil-specific k-space cell state from a previous time frame. The first machine learning model includes a forget gate and an input gate. The forget gate is configured to generate a mask for removing values from the coil-specific k-space cell state at k-space locations corresponding to a sampling pattern of the undersampled k-space data. The input gate is configured to control integration of the undersampled k-space data with k-space values retained from the coil-specific k-space cell state at unsampled locations to contribute to generating the filled k-space estimate. The forget gate and the corresponding input gate may be complementary to each other. The training includes optimizing at least one loss function including a k-space domain loss function determined based on the filled k-space estimate and the reference k-space data (e.g., Equation 7), a first image domain loss function configured to compare an inverse Fourier transform of the filled k-space estimate to the ground truth image (e.g., Equation 8), and/or a gate related loss function relating to performance of at least one of the forget gate or the input gate (e.g., Equation 9). In some embodiments, the gate related loss function as exemplified in Equation 9 includes at least one of a first component relating to the forget gate and a second component configured to enforce data fidelity by comparing the filled k-space estimate and the undersampled k-space data at sampled locations.

Second, a second machine learning model is trained to generate an image by processing a preliminary image derived from the filled k-space estimate and a coil-specific image-domain cell state from the previous time frame. The training includes optimizing a second image domain loss function configured to compare the image to the ground truth image (e.g., Equation 11).

At 1830, the process 1800 includes the joint training approach where the first and second machine learning models are trained together by accumulating gradients over at least a portion of the plurality of time frames and backpropagating the accumulated gradients to learn temporal relationships between consecutive time frames of the plurality of time frames. This temporal training approach enables the models to learn how to effectively utilize temporal information stored in the cell states across multiple time frames. The recurrent module including the first machine learning model (e.g., k-space RNN) and the second machine learning model (e.g., the image space RNN) may be trained by accumulating gradients over the entire time series and backpropagating together. The training may involve a loss function as exemplified by Equation 12.

In some embodiments, the training data includes, for each of a plurality of coil channels, training data sets for the plurality of time frames. In such embodiments, the process 1800 includes obtaining, for each of the plurality of coil channels, an image generated by the second machine learning model for a given time frame, and training a third machine learning model to combine the images from the plurality of coil channels into a combined image for the time frame. The training includes optimizing a loss function comparing the combined image to a ground truth combined image for the time frame. In some embodiments, the training of the third machine learning model is performed independently from the training of the first or second machine learning model, allowing for separate optimization of the coil combination function while the recurrent temporal processing models are trained jointly to learn temporal relationships.

The training process illustrated in FIG. 18 may be performed on various computing systems depending on operational requirements and infrastructure constraints. In some embodiments, at least one of the first, second, or third machine learning models may be trained on the same device or system where the models will subsequently be applied for real-time image reconstruction, such as directly on MRI scanner computing systems or integrated reconstruction workstations. This approach enables site-specific optimization and customization of the models based on local scanner characteristics, patient populations, and imaging protocols.

In some embodiments, the training is performed on separate high-performance computing systems, such as manufacturer development systems equipped with specialized graphics processing units (GPUs) and extensive computational resources optimized for machine learning workloads. Training may be conducted at manufacturing facilities, research institutions, or cloud-based computing platforms that can handle the computationally intensive gradient accumulation and backpropagation processes across large temporal datasets. Once trained, the resulting models can be deployed to clinical MRI systems through software updates, firmware installations, or downloadable model packages.

This distributed training approach allows for centralized model development using diverse, multi-institutional datasets while enabling deployment of optimized models across multiple clinical sites. The trained models may be further fine-tuned or adapted at individual clinical sites to account for local variations in scanner hardware, imaging protocols, or patient demographics while maintaining the core temporal reconstruction capabilities learned during the initial training phase.

FIG. 19 illustrates a process for reconstructing dynamic magnetic resonance images from undersampled multi-coil k-space data, in accordance with embodiments of the present technology.

At 1910, the process 1900 includes receiving undersampled k-space data for each of a plurality of time frames. The undersampled k-space data represents frequency domain measurements acquired during MRI scanning that are intentionally sparse to enable faster acquisition times while maintaining sufficient information for high-quality image reconstruction. The undersampling strategy may employ various acquisition patterns such as radial trajectories, spiral patterns, or Cartesian undersampling schemes optimized for temporal imaging applications. In some embodiments, the undersampled k-space data comprises multi-coil k-space samples from a plurality of receiver coils positioned around the imaging subject, where each receiver coil captures spatially-encoded frequency domain data with distinct sensitivity profiles that collectively provide comprehensive coverage of the imaging volume. The data reception process at step 1910 shares similar characteristics with step 1710 described in FIG. 17, including the handling of complex-valued k-space data, support for various sampling patterns such as golden-angle radial acquisition, and preprocessing operations such as non-uniform fast Fourier transform (NUFFT) gridding for non-Cartesian trajectories, though the specific implementation details may vary based on the broader methodological context of temporal memory-based reconstruction versus the more detailed machine learning pipeline described in the earlier figure.

At 1920, the process 1900 includes performing a reconstruction process. For one of the plurality of time frames, a reconstructed image is generated by processing the undersampled k-space data for the time frame together with prior information derived from at least one previous time frame of the plurality of time frames. The prior information includes at least one of: (i) a k-space memory (such as a k-space cell state) representing previously estimated or acquired k-space data, or (ii) an image-domain memory (such as an image-domain cell state) representing previously reconstructed images.

In some embodiments, the prior information comprises both the k-space memory and the image-domain memory, and the processing comprises sequentially applying the k-space memory to generate a filled k-space data and an intermediate reconstruction based on the filled k-space data, followed by applying the image-domain memory to refine the intermediate reconstruction. In some embodiments, the k-space memory is updated with the filled k-space data for use in processing a subsequent time frame. In some embodiments, the image-domain memory is updated with image information derived from the reconstructed image for use in processing a subsequent time frame. In some embodiments, only a portion of the prior information is involved in the reconstruction process. For example, reconstruction may utilize only k-space memory representing previously estimated or acquired k-space data, or alternatively, only image-domain memory representing previously reconstructed images.

In some embodiments, the processing includes using machine learning models trained to selectively retain and forget information in the k-space memory and/or image-domain memory based on temporal patterns embedded in the undersampled k-space data. This approach enables the system to adaptively determine which historical information is most relevant for reconstructing a current time frame.

For multi-coil implementations, the generation of a reconstructed image comprises, for each coil of the plurality of receiver coils, processing the undersampled k-space data corresponding to the coil together with coil-specific prior information to generate a coil-wise reconstructed image, and then combining the coil-wise reconstructed images from the plurality of receiver coils to generate the reconstructed image. In some embodiments, the coil-specific prior information comprises a coil-specific k-space memory and a coil-specific image-domain memory that are maintained independently for each coil. In some embodiments, each coil-wise reconstructed image is processed independently using the respective coil-specific prior information, and the coil combination is performed without cross-coil temporal information sharing.

In some embodiments, the coil-wise reconstructed images are combined by inputting the coil-wise reconstructed images into a neural network trained to perform coil combination and generate a combined reconstructed image. This machine learning approach to coil combination can learn optimal weighting strategies that account for spatial sensitivity variations and noise characteristics of individual receiver coils.

In some embodiments, the reconstructed image is generated for real-time medical imaging applications with a processing latency of less than 200 milliseconds per time frame, making the process 1900 suitable for interventional procedures that require immediate image feedback for clinical decision-making and procedural guidance. For example, the reconstruction latency is less than 150 milliseconds, 120 milliseconds, 100 milliseconds, 80 milliseconds, 60 milliseconds, 50 milliseconds, 40 milliseconds, 30 milliseconds, 20 milliseconds, or 10 milliseconds.

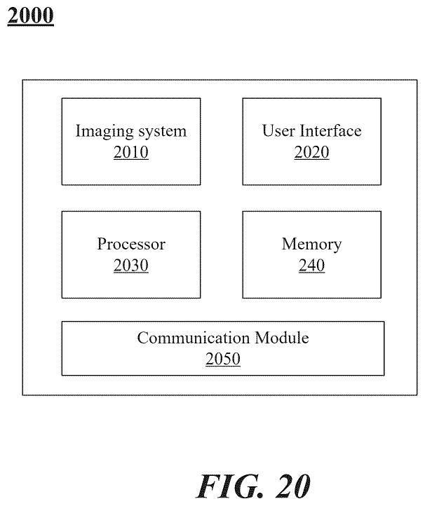

FIG. 20 illustrates a block diagram of a computer system for image processing, in accordance with embodiment of the present technology. For instance, one or more of processes disclosed herein, including processes 1700-1900 illustrated in FIGS. 17-19, respectively, may be implemented on the system 2000. The system 2000 includes an imaging system 2010, a user interface 2020, one or more processors 2030, memory 2040, and a communication module 2050. The imaging system 2010 encompasses an imager that is configured to acquire k-space data, e.g., undersampled multi-coil k-space data, from a magnetic resonance imaging scanner. The imaging system 2010 includes receiver coils positioned around a subject, or a portion thereof, for capturing spatially-encoded frequency domain measurements during dynamic imaging sequences.

The user interface 2020 provides means for user interaction with the system 2000, allowing for control of imaging parameters such as temporal resolution settings, selection of anatomical imaging protocols, real-time display of reconstructed image sequences, and adjustment of reconstruction quality metrics for clinical review and procedural guidance. The user interface 2020 may include or be implemented on various input and output devices such as high-resolution display monitors for real-time visualization of reconstructed cardiac images during interventional procedures, touchscreen interfaces for intuitive parameter adjustment and protocol selection, keyboard and mouse input devices for detailed system configuration and data entry, trackball or joystick controls for navigating through temporal image sequences, voice recognition systems for hands-free operation during sterile procedures, haptic feedback devices for tactile interaction with three-dimensional reconstructed anatomical models, and specialized control panels with dedicated buttons and knobs for rapid adjustment of critical imaging parameters during time-sensitive interventional procedures. The user interface 2020 may also include audio output devices for providing audible alerts regarding reconstruction quality metrics, system status notifications, or completion of processing tasks, enabling clinicians to maintain focus on patient care while staying informed of system operations.

The processor(s) 2030 can execute the computational algorithms that perform image processing, including the machine learning models with k-space and image-domain cell states for temporal reconstruction, gradient accumulation and backpropagation for model training, coil combination algorithms, and real-time image generation with latencies suitable for interventional procedures. In some embodiments, the processor(s) 2030 is configured to function as a controller that coordinates the operation of system components, manages data flow between the imaging system and reconstruction algorithms, schedules computational tasks to meet real-time latency requirements, and orchestrates the sequential processing of k-space data through the temporal reconstruction pipeline.

The memory 2040 is configured to store training datasets comprising reference k-space data and ground truth images, trained machine learning model parameters including neural network weights for the recurrent architectures, temporal cell state information for maintaining k-space and image-domain memories across time frames, and reconstructed image sequences for clinical analysis and archival storage.

The communication module 2050 is configured to enable data exchange between system components (e.g., 2010-2040) and/or with external systems, including transmission of reconstructed images to picture archiving and communication systems (PACS), network connectivity for remote model updates and training data sharing, integration with hospital information systems for patient data management, and communication with interventional equipment for real-time procedural guidance applications. The communication module 2050 may facilitate communication via a wired connection, a wireless connection, or a combination thereof.

Together, these components form an integrated system that enables real-time magnetic resonance image reconstruction from undersampled data using temporally-aware neural networks, supporting both clinical imaging workflows and interventional procedures requiring immediate image feedback with processing latencies under 200 milliseconds per time frame.

The FOURIER-Net framework as disclosed herein, including the combination of a k-space recurrent neural network, an image-domain convLSTM and a learned coil-combination UNct, achieves its acceleration and noise-suppression advantages by exploiting inter-frame temporal redundancy in dynamic MRI acquisition. While the exemplary implementations are described based on cardiac cine data, the architectural principles (spoke-aware memory gating in k-space, abstract temporal memory in image-space, and per-coil explainability) are anatomy-agnostic and can be applied in other clinical or non-clinical domains in which rapid, continuously updated images are desirable from severely undersampled data. Exemplary non-cardiac use-cases include abdominal and pelvic organs subject to respiratory-influenced motion, oncology therapy guidance and non-cardiac interventional MRI, fetal and pediatric applications (non-cardiac), gastrointestinal motility imaging, and dynamic contrast-enhanced (DCE) and perfusion imaging.

In each of these settings, the distinctive attributes that underlie FOURIER-Net's cardiac performance-spoke-aware k-space memory management, image-domain temporal denoising, and fast, coil-specific inference-translate directly to improved image quality, latency, and/or robustness. The technology therefore constitutes a broadly applicable platform for real-time or near-real-time MRI across diverse anatomies and clinical workflows where dynamic motion, patient cooperation constraints, or interventional time pressure traditionally force compromises in either image quality or acquisition speed.

The technology represents a paradigm shift in dynamic MRI reconstruction by leveraging temporal relationships between successive time frames to reconstruct high-quality images from severely undersampled data. Rather than treating each frame independently as conventional approaches do, the technology maintains and updates memory states that capture relevant information from previous time points to guide reconstruction of the current frame. This temporal memory-guided approach enables the system to synthesize missing information and improve image quality by exploiting the inherent temporal redundancy present in dynamic MRI acquisitions.

The system implements a dual-domain temporal processing strategy that operates in both k-space (frequency domain) and image domain, with separate temporal memory mechanisms optimized for each domain's unique characteristics. This dual approach allows for sophisticated temporal processing that addresses different types of artifacts and temporal relationships inherent to each domain, providing a comprehensive solution for real-time dynamic MRI reconstruction.

The technology implements a sophisticated k-space temporal memory system that maintains previously reconstructed k-space data across time frames and uses known sampling patterns, e.g., radial spoke locations, to intelligently manage memory updates. The system selectively forgets outdated information at newly sampled locations while enforcing data fidelity by preserving newly acquired measurements. Simultaneously, it retains and adapts information at unsampled locations to synthesize missing k-space values. The implementation includes supervised gating mechanisms that leverage acquisition geometry for optimal memory management, ensuring that the temporal memory remains relevant and accurate while avoiding artifacts that may arise from outdated information.

Beyond k-space processing, the system maintains an abstract temporal memory state in the image domain that captures temporal patterns without storing literal previous images. This memory performs temporal denoising and artifact suppression by recognizing patterns that evolve consistently versus those that represent noise or rotating artifacts commonly seen in undersampled radial acquisitions. The abstract nature of this memory enables smooth temporal transitions while preserving anatomical detail and motion, providing a flexible framework that adapts to various types of dynamic processes.

The technology employs a recurrent neural network architecture specifically designed to process continuous streams of undersampled data packets without requiring fixed sliding windows. This approach enables real-time or near-real-time reconstruction with millisecond-scale inference latency, avoiding the computational overhead of repeatedly processing overlapping time windows that characterizes conventional sliding-window approaches. The streaming capability is suitable for interventional applications where immediate image feedback is beneficial for procedural guidance.

The system processes each receiver coil independently using a shared temporal processing architecture while maintaining separate temporal memory states for each coil. This per-coil approach applies consistent temporal processing principles across all coils before combining the coil-specific reconstructions using learned coil combination techniques. This strategy improves both computational efficiency and reconstruction quality by allowing the temporal processing to adapt to the specific characteristics of each coil's data while maintaining overall temporal consistency.

The technology implements a modular architecture that separates k-space and image-domain processing into distinct, trainable modules. This separation enables intermediate supervision and validation at each processing stage, providing explainability through inspection of k-space estimates and per-coil image reconstructions. The modular design facilitates debugging, optimization, and adaptation to different clinical applications while maintaining the overall temporal processing framework.

In some embodiments, the system manages complex-valued k-space data by separating it into magnitude/phase or real/imaginary components and applies domain-specific processing techniques suitable or optimized for complex MRI data characteristics. The technology may maintain phase information throughout the reconstruction pipeline until final magnitude display, ensuring that no critical information is lost during processing. The system may employ golden-angle radial acquisition patterns that provide uniform k-space coverage, leveraging the flexibility of radial sampling for motion robustness and real-time imaging while adapting to varying numbers of spokes per frame. The system may employ a scaling approach, e.g., logarithmic transformation, normalization techniques, or dynamic range compression, to handle magnitude data whose absolute values may span several orders of magnitude, e.g., from low-frequency central k-space regions with high signal amplitudes to high-frequency peripheral regions with lower signal levels. This scaling approach ensures that the machine learning models can effectively process k-space data across the full dynamic range without numerical instabilities or gradient vanishing problems that could occur when training neural networks on raw magnitude values that vary from near-zero to extremely large numbers, e.g., in the central k-space regions where low spatial frequency information is concentrated.

The technology incorporates a deployment-optimized design that separates training methodology from deployment requirements to enable practical clinical implementation. The system supports continuous operation on streaming MRI data without requiring retrospective binning or breath-holding, making it suitable for challenging patient populations. The computational efficiency is maintained at levels suitable for real-time interventional procedures requiring sub-200 ms latency, representing a significant advance over existing approaches that cannot meet such stringent timing requirements.

The technology achieves orders-of-magnitude faster inference compared to sliding-window CNN approaches, processing hundreds of frames per second versus tens of FPS for conventional methods, while maintaining competitive image quality with SSIM scores of, e.g., approximately 0.89. This performance enables severe undersampling with as few as, e.g., 10 spokes per frame while maintaining acceptable image quality for clinical use. The approach supports real-time interventional procedures requiring immediate image feedback and accommodates patient populations unable to hold breath or remain still, such as pediatric and fetal imaging applications. The architectural generalizability extends the technology's applicability to multiple anatomical regions beyond cardiac imaging, including abdominal organs under respiratory motion, interventional oncology procedures, gastrointestinal motility studies, and dynamic contrast-enhanced imaging protocols.

The technology represents an advancement in dynamic MRI reconstruction by exploiting temporal redundancy through sophisticated memory mechanisms while maintaining the speed and robustness needed for clinical deployment across diverse applications and patient populations.

The following examples are illustrative of several embodiments of the present technology:
Solution 1. A method for magnetic resonance imaging, the method comprising: (a) receiving, for a time frame, a k-space data packet from a magnetic resonance imaging (MRI) system, the k-space data packet comprising an undersampled k-space sample for each of a plurality of coil channels; and (b) for each of the plurality of coil channels, (i) generating a filled k-space estimate by inputting an undersampled k-space sample acquired by the coil channel and a coil-specific k-space cell state from a previous time frame into a first machine learning model, wherein the coil-specific k-space cell state stores temporal information from prior k-space reconstructions for the coil channel; (ii) transforming the filled k-space estimate using an inverse Fourier transform to obtain a preliminary image; and (iii) producing an image by inputting the preliminary image and a coil-specific image-domain cell state from the previous time frame into a second machine-learning model, wherein the coil-specific image-domain cell state stores temporal information from prior image reconstructions; and (c) generating a combined image for the time frame by combining the images of the plurality of coil channels. The method allows real-time or near real-time acquisition of MRI images from under-sampled k-space data by integrating dual-domain temporal memory mechanisms that maintain coil-specific k-space and image-domain cell states across one or more time frames, thereby providing diagnostically acceptable images from severely undersampled k-space data while achieving accelerated processing speed compared to conventional approaches. The method has practical application to clinical procedures that benefit from immediate image feedback and continuous streaming MRI acquisitions.
Solution 2. The method of any one or more of solution 1 or any other solutions disclosed herein, wherein the first machine learning model comprises a recurrent neural network architecture.
Solution 3. The method of any one or more of solution 1 or any other solutions disclosed herein, wherein the first machine learning model comprises: a forget gate configured to generate a mask for removing values from the coil-specific k-space cell state at k-space sampled locations corresponding to newly acquired k-space samples for the coil channel; and an input gate configured to control integration of the newly acquired k-space samples with k-space values retained from the coil-specific k-space cell state at unsampled locations to contribute to generating the filled k-space estimate.
Solution 4. The method of any one or more of solution 1 or any other solutions disclosed herein, comprising updating the coil-specific k-space cell state with the filled k-space estimate, wherein the updated coil-specific k-space cell state is configured for use as a coil-specific k-space cell state from a previous time frame in generating a filled k-space estimate for a subsequent time frame for the coil channel.
Solution 5. The method of any one or more of solution 1 or any other solutions disclosed herein, wherein the k-space data packet comprises complex-valued data, and the method further comprises separating the complex-valued data into magnitude and phase components for processing by the first machine learning model.
Solution 6. The method of any one or more of solution 1 or any other solutions disclosed herein, wherein the k-space data packet is acquired using a golden-angle radial sampling pattern.
Solution 7. The method of any one or more of solution 1 or any other solutions disclosed herein, wherein: the k-space data packet comprises non-Cartesian k-space samples; and the method comprises mapping the samples to a Cartesian grid by performing a gridding operation prior to input into the first machine learning model. In some embodiments, the gridding operation may be performed using a non-uniform fast Fourier transform (NUFFT) technique.
Solution 8. The method of any one or more of solution 1 or any other solutions disclosed herein, wherein the second machine learning model comprises a recurrent neural network architecture.
Solution 9. The method of any one or more of solution 1 or any other solutions disclosed herein, wherein the second machine learning model is trained to determine an updated coil-specific image-domain cell state that encodes a temporal relationship between the preliminary image and at least one previous time frame for the same coil channel, the updated coil-specific image-domain cell state being configured for use as a coil-specific image-domain cell state from a previous time frame in reconstructing an image for a subsequent time frame for the same coil channel.
Solution 10. The method of any one or more of solution 9 or any other solutions disclosed herein, wherein the second machine learning model comprises: a forget gate configured to generate a mask for selectively removing information from the coil-specific image-domain cell state based on the preliminary image; and an input gate configured to control integration of new information derived from the preliminary image with retained information from the coil-specific image-domain cell state to contribute to generating the image.
Solution 11. The method of any one or more of solution 1 or any other solutions disclosed herein, wherein the combining the images comprises inputting the images into a third machine learning model that is trained to perform coil combination to generate the combined image.
Solution 12. The method of any one or more of solution 1 or any other solutions disclosed herein, further comprising compensating for temporal prediction lag by performing at least one of: configuring the first machine learning model to limit retention of historical k-space data in the coil-specific k-space cell state to a predetermined number of prior time frames prior to the time frame; or applying a temporal shift correction to align reconstructed images with their corresponding acquisition time frames.
Solution 13. The method of any one or more of solution 12 or any other solutions disclosed herein, wherein the configuring the first machine learning model comprises configuring a forget gate of the first machine learning model to remove k-space data from the coil-specific k-space cell state that exceeds the predetermined number of prior time frames.
Solution 14. The method of any one or more of solution 1 or any other solutions disclosed herein, comprising: generating a combined image by repeating operations (a) through (c) for each of a plurality of time frames; and generating an image sequence for the plurality of time frames based on a plurality of the combined images.
Solution 15. The method of any one or more of solution 1 or any other solutions disclosed herein, wherein the method is applied to reconstruct images of an anatomical region that includes a heart, a lung, an abdominal organ, a pelvic organ, a fetal body, a pediatric body, a gastrointestinal tract, or knee movement.
Solution 16. The method of any one or more of solution 1 or any other solutions disclosed herein, wherein the method is configured for real-time or near-real-time reconstruction with a latency of less than 200 milliseconds per time frame.
Solution 17. The method of any one or more of solution 1 or any other solutions disclosed herein, comprising evaluating quality of the generated image using at least one metric including structural similarity index (SSIM), L1 loss, and root mean squared error (RMSE).
Solution 18. The method of any one or more of solution 1 or any other solutions disclosed herein, wherein each coil channel of the plurality of coil channels operates independently with its own coil-specific k-space cell state and coil-specific image-domain cell state, such that temporal information for each coil channel is maintained separately without cross-coil information sharing.
Solution 19. A computer-implemented method, comprising: obtaining training data comprising, for each of a plurality of time frames, a training data set comprising reference k-space data, a ground truth image, and undersampled k-space data for the time frame; iteratively performing, for each of the plurality of time frames: (i) training a first machine learning model to generate a filled k-space estimate by processing the undersampled k-space data and a coil-specific k-space cell state from a previous time frame, wherein: the first machine learning model comprises a forget gate and an input gate, the forget gate is configured to generate a mask for removing values from the coil-specific k-space cell state at k-space locations corresponding to a sampling pattern of the undersampled k-space data; and the input gate is configured to control integration of the undersampled k-space data with k-space values retained from the coil-specific k-space cell state at unsampled locations to contribute to generating the filled k-space estimate; and the training comprises optimizing at least one loss function including a k-space domain loss function determined based on the filled k-space estimate and the reference k-space data, a first image domain loss function configured to compare an inverse Fourier transform of the filled k-space estimate to the ground truth image, and a gate related loss function relating to performance of at least one of the forget gate or the input gate; and (ii) training a second machine learning model to generate an image by processing a preliminary image derived from the filled k-space estimate and a coil-specific image-domain cell state from the previous time frame, wherein the training comprises optimizing a second image domain loss function configured to compare the image to the ground truth image; and training the first and second machine learning models by accumulating gradients over at least a portion of the plurality of time frames and backpropagating the accumulated gradients to learn temporal relationships between consecutive time frames of the plurality of time frames. The method enables training of machine learning models configured to reconstruct high-quality MRI images from undersampled k-space data by integrating temporal memory mechanisms across several successive time frames through optimized gating functions and multi-domain loss functions that enforce data fidelity in both k-space and image domains. The method allows creations of deployable MRI reconstruction systems that provide real-time or near real-time imaging capabilities for clinical procedures and enable diagnostic imaging from undersampled acquisitions that reduce image acquisition times.
Solution 20. The method of any one or more of solution 19 or any other solutions disclosed herein, wherein the obtaining the training data comprises at least one of: determining reference k-space data by performing a Fourier transform of a corresponding ground truth image of one of the plurality of time frames; or determining the undersampled k-space data by undersampling the reference k-space data.
Solution 21. The method of any one or more of solution 19 or any other solutions disclosed herein, wherein the gate related loss function comprises at least one of a first component relating to the forget gate and a second component configured to enforce data fidelity by comparing the filled k-space estimate and the undersampled k-space data at sampled locations.
Solution 22. The method of any one or more of solution 19 or any other solutions disclosed herein, wherein: the training data comprise, for each of a plurality of coil channels, training data sets for the plurality of time frames; and the method comprises, for one of the plurality of time frames: obtaining, for each of the plurality of coil channels, an image generated by the second machine learning model for the time frame; and training a third machine learning model to combine the images from the plurality of coil channels into a combined image for the time frame, wherein the training comprises optimizing a loss function comparing the combined image to a ground truth combined image for the time frame.
Solution 23. The method of any one or more of solution 22 or any other solutions disclosed herein, wherein the training of the third machine learning model is independent from the training of the first or second machine learning model.
Solution 24. A method for magnetic resonance imaging, comprising: receiving, for each of a plurality of time frames, undersampled k-space data; for one of the plurality of time frames, generating a reconstructed image by processing the undersampled k-space data for the time frame together with prior information derived from at least one previous time frame of the plurality of time frames, wherein the prior information comprises at least one of: (i) a k-space memory representing previously estimated or acquired k-space data, or (ii) an image-domain memory representing previously reconstructed images. The method allows real-time or near real-time acquisition of MRI images from under-sampled k-space data by integrating dual-domain temporal memory mechanisms that maintain k-space and image-domain cell states across successive time frames, thereby providing diagnostically acceptable images from severely undersampled k-space data while achieving accelerated processing speed compared to conventional approaches. The method has practical application to clinical procedures that benefit from immediate image feedback and continuous streaming MRI acquisitions.
Solution 25. The method of any one or more of solution 24 or any other solutions disclosed herein, wherein the prior information comprises both the k-space memory and the image-domain memory, and the processing comprises: sequentially applying the k-space memory to generate a filled k-space data and an intermediate reconstruction based on the filled k-space data; and applying the image-domain memory to refine the intermediate reconstruction.
Solution 26. The method of any one or more of solution 24 or any other solutions disclosed herein, wherein the k-space memory is updated with the filled k-space data for use in processing a subsequent time frame.
Solution 27. The method of any one or more of solution 24 or any other solutions disclosed herein, wherein the image-domain memory is updated with image information derived from the reconstructed image for use in processing a subsequent time frame.
Solution 28. The method of any one or more of solution 24 or any other solutions disclosed herein, wherein the processing comprises using machine learning models trained to selectively retain and forget information in the k-space memory and image-domain memory based on temporal patterns embedded in the undersampled k-space data.
Solution 29. The method of any one or more of solution 24 or any other solutions disclosed herein, wherein the undersampled k-space data comprises multi-coil k-space samples from a plurality of receiver coils, and the generating a reconstructed image comprises: for each coil of the plurality of receiver coils, processing the undersampled k-space data corresponding to the coil together with coil-specific prior information to generate a coil-wise reconstructed image; and combining the coil-wise reconstructed images from the plurality of receiver coils to generate the reconstructed image.
Solution 30. The method of any one or more of solution 29 or any other solutions disclosed herein, wherein the coil-specific prior information comprises a coil-specific k-space memory and a coil-specific image-domain memory that are maintained independently for each coil.
Solution 31. The method of any one or more of solution 29 or any other solutions disclosed herein, wherein the combining the coil-wise reconstructed images comprises inputting the coil-wise reconstructed images into a neural network trained to perform coil combination and generate a single-channel reconstructed image.
Solution 32. The method of any one or more of solution 29 or any other solutions disclosed herein, wherein each coil-wise reconstructed image is processed independently using the respective coil-specific prior information, and the coil combination is performed without cross-coil temporal information sharing.
Solution 33. The method of any one or more of solution 24 or any other solutions disclosed herein, wherein the reconstructed image is generated for real-time medical imaging applications with a processing latency of less than 200 milliseconds per time frame.
Solution 34. A method for fast magnetic resonance imaging reconstruction, comprising: receiving, by a first neural network, an input comprising undersampled MRI frequency data; obtaining, based on the input, an output from the first neural network that comprises missing frequencies in the undersampled MRI frequency data; correcting the undersampled MRI frequency data according to the output such that the undersampled MRI frequency data includes the missing frequencies; converting, after the correcting, the undersampled MRI frequency data into a predicted MRI image using a second neural network; and obtaining a denoised MRI image by performing a coil-combination operation on the predicted MRI image using a third neural network configured to remove artifacts from the predicted MRI image.
Solution 35. The method of any one or more of solution 34 or any other solutions disclosed herein, wherein the first neural network is a recurrent neural network.
Solution 36. The method of any one or more of solution 34 or any other solutions disclosed herein, wherein the second neural network is a convolutional Long Short-Term Memory recurrent neural network.
Solution 37. The method of any one or more of solution 34 or any other solutions disclosed herein, wherein the coil-combination operation is performing by a UNet convolutional neural network.
Solution 38. The method of any one or more of solution 34 or any other solutions disclosed herein, wherein the undersampled MRI frequency data comprises a time series of MRI image frames.
Solution 39. A system, comprising: at least one processor; and memory with instructions stored thereon, wherein the instructions upon execution by the at least one processor, cause the at least one processor to performing the method of any one or more solutions disclosed herein.
Solution 40. At least one non-transitory computer-readable medium that stores computer-executable instructions that, when executed by one or more processors, cause an apparatus to implement the methods described herein.

Various operations disclosed herein can be implemented using a processor/controller configured to include, or be coupled to, a memory that stores processor executable code that causes the processor/controller carry out various computations and processing of information. The processor/controller can further generate and transmit/receive suitable information to/from the various system components, as well as suitable input/output (IO) capabilities (e.g., wired or wireless) to transmit and receive commands and/or data. The processor/controller may, for example, provide signals to control the operation of various components such as excitation sources and detectors that are disclosed herein. The processor/controller may be further configured to perform various method steps and computations that are disclosed in this patent document.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Only a few implementations and examples are described and other implementations, enhancements and variations can be made based on what is described and illustrated in this patent document.

What is claimed is:

1. A method for magnetic resonance imaging, the method comprising:
(a) receiving, for a time frame, a k-space data packet from a magnetic resonance imaging (MRI) system, the k-space data packet comprising an undersampled k-space sample for each of a plurality of coil channels; and
(b) for each of the plurality of coil channels,
(i) generating a filled k-space estimate by inputting an undersampled k-space sample acquired by the coil channel and a coil-specific k-space cell state from a previous time frame into a first machine learning model, wherein the coil-specific k-space cell state stores temporal information from prior k-space reconstructions for the coil channel;
(ii) transforming the filled k-space estimate using an inverse Fourier transform to obtain a preliminary image; and
(iii) producing an image by inputting the preliminary image and a coil-specific image-domain cell state from the previous time frame into a second machine-learning model, wherein the coil-specific image-domain cell state stores temporal information from prior image reconstructions; and
(c) generating a combined image for the time frame by combining the images of the plurality of coil channels.

2. The method of claim 1, wherein at least one of the first machine learning model or the second machine learning model comprises a recurrent neural network architecture.

3. The method of claim 1, wherein the first machine learning model comprises:
a forget gate configured to generate a mask for removing values from the coil-specific k-space cell state at k-space sampled locations corresponding to newly acquired k-space samples for the coil channel; and
an input gate configured to control integration of the newly acquired k-space samples with k-space values retained from the coil-specific k-space cell state at unsampled locations to contribute to generating the filled k-space estimate.

4. The method of claim 1, comprising updating the coil-specific k-space cell state with the filled k-space estimate, wherein the updated coil-specific k-space cell state is configured for use as a coil-specific k-space cell state from a previous time frame in generating a filled k-space estimate for a subsequent time frame for the coil channel.

5. The method of claim 1, wherein the k-space data packet comprises complex-valued data, and the method further comprises separating the complex-valued data into magnitude and phase components for processing by the first machine learning model.

6. The method of claim 1, wherein:
the k-space data packet comprises non-Cartesian k-space samples; and
the method comprises mapping the samples onto a Cartesian grid by performing a gridding operation prior to input into the first machine learning model.

7. The method of claim 1, wherein the second machine learning model is trained to determine an updated coil-specific image-domain cell state that encodes a temporal relationship between the preliminary image and at least one previous time frame for the same coil channel, the updated coil-specific image-domain cell state being configured for use as a coil-specific image-domain cell state from a previous time frame in reconstructing an image for a subsequent time frame for the same coil channel.

8. The method of claim 7, wherein the second machine learning model comprises:
a forget gate configured to generate a mask for selectively removing information from the coil-specific image-domain cell state based on the preliminary image; and
an input gate configured to control integration of new information derived from the preliminary image with retained information from the coil-specific image-domain cell state to contribute to generating the image.

9. The method of claim 1, wherein the combining the images comprises inputting the images into a third machine learning model that is trained to perform coil combination to generate the combined image.

10. The method of claim 1, comprising compensating for temporal prediction lag by performing at least one of:
configuring the first machine learning model to limit retention of historical k-space data in the coil-specific k-space cell state to a predetermined number of prior time frames prior to the time frame; or
applying a temporal shift correction to align reconstructed images with their corresponding acquisition time frames.

11. The method of claim 10, wherein the configuring the first machine learning model comprises configuring a forget gate of the first machine learning model to remove k-space data from the coil-specific k-space cell state that exceeds the predetermined number of prior time frames.

12. The method of claim 1, comprising:
generating a combined image by repeating operations (a) through (c) for each of a plurality of time frames; and
generating an image sequence for the plurality of time frames based on a plurality of the combined images.

13. The method of claim 1, wherein the method is applied to reconstruct images of an anatomical region that includes a heart, a lung, an abdominal organ, a pelvic organ, a fetal body, a pediatric body, a gastrointestinal tract, or knee movement.

14. The method of claim 1, wherein the method is configured for real-time or near-real-time reconstruction with a latency of less than 200 milliseconds per time frame.

15. The method of claim 1, comprising evaluating quality of the generated image using at least one metric including structural similarity index (SSIM), L1 loss, and root mean squared error (RMSE).

16. The method of claim 1, wherein each coil channel of the plurality of coil channels operates independently with its own coil-specific k-space cell state and coil-specific image-domain cell state, such that temporal information for each coil channel is maintained separately without cross-coil information sharing.

17. A computer-implemented method, comprising:
obtaining training data comprising, for each of a plurality of time frames, a training data set comprising reference k-space data, a ground truth image, and undersampled k-space data for the time frame;
iteratively performing, for each of the plurality of time frames:
(i) training a first machine learning model to generate a filled k-space estimate by processing the undersampled k-space data and a coil-specific k-space cell state from a previous time frame, wherein:
the first machine learning model comprises a forget gate and an input gate,
the forget gate is configured to generate a mask for removing values from the coil-specific k-space cell state at k-space locations corresponding to a sampling pattern of the undersampled k-space data; and
the input gate is configured to control integration of the undersampled k-space data with k-space values retained from the coil-specific k-space cell state at unsampled locations to contribute to generating the filled k-space estimate; and
the training comprises optimizing at least one loss function including a k-space domain loss function determined based on the filled k-space estimate and the reference k-space data, a first image domain loss function configured to compare an inverse Fourier transform of the filled k-space estimate to the ground truth image, and a gate related loss function relating to performance of at least one of the forget gate or the input gate; and
(ii) training a second machine learning model to generate an image by processing a preliminary image derived from the filled k-space estimate and a coil-specific image-domain cell state from the previous time frame, wherein the training comprises optimizing a second image domain loss function configured to compare the image to the ground truth image; and
training the first and second machine learning models by accumulating gradients over at least a portion of the plurality of time frames and backpropagating the accumulated gradients to learn temporal relationships between consecutive time frames of the plurality of time frames.

18. The method of claim 17, wherein the obtaining the training data comprises at least one of:
determining reference k-space data by performing a Fourier transform of a corresponding ground truth image of one of the plurality of time frames; or
determining the undersampled k-space data by undersampling the reference k-space data.

19. The method of claim 17, wherein the gate related loss function comprises at least one of a first component relating to the forget gate and a second component configured to enforce data fidelity by comparing the filled k-space estimate and the undersampled k-space data at sampled locations.

20. A method for magnetic resonance imaging, comprising:
receiving, for each of a plurality of time frames, undersampled k-space data;
for one of the plurality of time frames, generating a reconstructed image by processing the undersampled k-space data for the time frame together with prior information derived from at least one previous time frame of the plurality of time frames, wherein the prior information comprises at least one of: (i) a k-space memory representing previously estimated or acquired k-space data, or (ii) an image-domain memory representing previously reconstructed images.
